(19) United States
(12) Patent Application Publication
(10) Pub. No.: US 2023/0259521 A1
(43) Pub. Date: Aug. 17, 2023

(54) METADATA-BASED DATA PROCESSING

(71) Applicant: Insight Direct USA, Inc., Tempe, AZ (US)

(72) Inventors: Bennie Alfons Haelen, Anthem, AZ (US); Dirk Renick, Albany, CA (US)

(21) Appl. No.: 17/709,916

(22) Filed: Mar. 31, 2022

Related U.S. Application Data
(63) Continuation-in-part of application No. 17/670,896, filed on Feb. 14, 2022.

(51) Int. Cl. G06F 16/25; G06F 16/28; G06F 16/22

(52) U.S. Cl. CPC G06F 16/254; G06F 16/283; G06F 16/2282

(57) ABSTRACT

A method of processing data includes defining metadata sets of process definition metadata based on a process definition, organizing data source metadata corresponding to a plurality of data sources into a data structure, and executing one or more steps of the data processing system according to the process definition. A first step is an ordered sequence of activities of a data ingestion pipeline. Executing the ordered sequence of activities includes connecting to one of the data sources using a portion of the metadata, accessing a respective data object specified by the portion of the metadata, and storing the respective data object in a data lake. The method further includes generating runtime metadata during an execution of the one or more data processing system steps, storing the runtime metadata, and forming a metadata data store that integrates the runtime metadata and the metadata sets of process definition metadata.

### CROSS REFERNCE TO RELATED APPLICATION(S)

This application is a continuation-in-part of U.S. Application No. 17/670,896 filed Feb. 14, 2022, for “SCALABLE METADATA-DRIVEN DATA INGESTION PIPELINE” by D. Renick.

### BACKGROUND

The present disclosure relates generally to data aggregation, and more specifically to data ingestion pipelines.

Organizations use business intelligence (BI) technologies to generate actionable business insights and other analytics from large data sets (i.e., big data). Business data is often stored in various data sources, including on-premises data stores and cloud data stores. An organization may want to aggregate data from its various data sources in some way to provide, for example, a holistic view of the business or other insights.

To analyze its business data, an organization can aggregate the data in a centralized location, such as a cloud-based data lake, via a data ingestion pipeline. Two common data ingestion procedures that may be used for aggregating data are extract-transform-load (ETL) and extract-load-transform (ELT). In an ETL procedure, data is extracted from data sources, transformed using a series of rules or functions to prepare it for loading into an end target store, and loaded into the end target store. ELT is a variation of ETL. In an ELT procedure, data extracted from the data sources is loaded into the end target store before any transformation steps. Either ETL or ELT can be used for ingesting data, depending on the use case.

Data warehouses are a type of data store that can be used to organize business data in a format that is more approachable for analyzing the data. A typical data warehouse model can include dimension and fact tables, which are two types of relational tables. Fact tables record measurements or metrics (i.e., facts) for an event, such as a business process. Dimension tables are companion tables to fact tables that store descriptive information or attributes (i.e., dimensions) about the facts. Each fact table can reference several dimension tables. Star and snowflake schemas are database organizations where one or more fact tables reference a number of dimension tables.

Organizations can build fully custom data movement or processing components and systems or can utilize commercially available platforms, such as Microsoft Azure Data Factory or Amazon AWS Data Pipeline, to create custom workflows, i.e., pipelines, for moving and transforming data.

### SUMMARY

In one example, a method of processing electronic data in a data processing system includes defining metadata sets of process definition metadata based on a process definition of the data processing system. The metadata sets include a first set of metadata corresponding to a processing step of the data processing system, a second set of metadata corresponding to a processing step successor that succeeds the processing step in the data processing system, and a third set of metadata corresponding to a data object that is produced or consumed by the processing step in the data processing system. The method further includes organizing data source metadata corresponding to a plurality of data sources into a data structure. The data source metadata includes information that enables identifying and connecting to each data source of the plurality of data sources. The method further includes storing the data structure on a database such that the data structure is configured to be queried to retrieve the data source metadata and executing one or more steps of the data processing system via a computer device according to the process definition. A first step of the data processing system is an ordered sequence of activities that corresponds to a data ingestion pipeline that is initiated by querying the data structure to retrieve metadata corresponding to one or more data sources of the plurality of data sources. Executing the ordered sequence of activities includes connecting to a respective one of the one or more data sources using a portion of the metadata that corresponds to the respective one of the one or more data sources to form a connection to the respective one of the one or more data sources; accessing, from the respective one of the one or more data sources via the connection, a respective data object specified by the portion of the metadata that corresponds to the respective one of the one or more data sources; and storing the respective data object in a data lake, the data lake being remote from each of the data sources. The method further includes generating runtime metadata during an execution of the one or more data processing system steps. The runtime metadata includes metadata that corresponds to an instance of the processing step and metadata that corresponds to an instance of the data object. The method further includes storing the runtime metadata during the execution of the one or more data processing system steps and forming a metadata data store that integrates the runtime metadata and the metadata sets of process definition metadata.

### BRIEF DESCRIPTION OF THE DRAWINGS

FIG. 1 is a simplified schematic diagram of a data pipeline system for ingesting data from various data sources into cloud storage.

FIG. 2 is a schematic block diagram showing details of the data pipeline system.

FIG. 3 is a simplified table of illustrative data source metadata.

FIG. 4 is a process flowchart illustrating steps of a process for ingesting data from various data sources into cloud storage.

FIG. 5 is a schematic block diagram showing details of an embodiment of the data pipeline system that includes secure access credentials storage.

FIG. 6 is a process flowchart illustrating steps of an embodiment of the process for ingesting data including steps for obtaining access credentials.

FIG. 7 is a schematic block diagram showing details of an embodiment of the data pipeline system that includes an additional database.

FIG. 8 is a process flowchart illustrating steps of an embodiment of the process for ingesting data including a step for transforming a data object.

FIG. 9 is a schematic block diagram of a data processing system that includes templates for creating dimension and fact tables.

FIG. 10 is a schematic block diagram showing details of a class infrastructure for the templates of FIG. 9.

FIG. 11 is a schematic block diagram showing details of an example dimension template.

FIG. 12 is a schematic block diagram showing details of an example fact template.

FIG. 13 is a process flowchart illustrating steps of a process for creating dimension or fact tables in the data processing system of FIG. 9.

FIG. 14 is a schematic block diagram of a data processing system for generating and storing metadata.

FIG. 15 is a schematic block diagram of an example schema for organizing metadata in the data processing system of FIG. 14.

FIG. 16 is a process flowchart illustrating steps of a process for generating and storing metadata in the data processing system of FIG. 14.

### DETAILED DESCRIPTION

### Scalable Metadata-Driven Data Ingestion Pipeline

According to techniques of this disclosure, a data pipeline integrates data source metadata to ingest large amounts of data from various data sources into cloud-based data storage (e.g., a data lake) in a secure and scalable manner. One concern with data aggregation in the big data context is that moving large amounts of data into the cloud can be onerous. Significantly, a typical approach to data ingestion involving individual data ingestion pipelines does not scale well. For example, if an organization has a variety of separate data stores where business data is stored that the organization wants to aggregate in the cloud for analytics, then the traditional approach might be to write a program (i.e., a data ingestion pipeline) for each data source to direct the data stored therein to the cloud data store. This rapidly becomes impractical if the organization has many (e.g., one hundred, five hundred, etc.) source data stores because an individual data ingestion pipeline would need to be written and maintained for each separate data source.

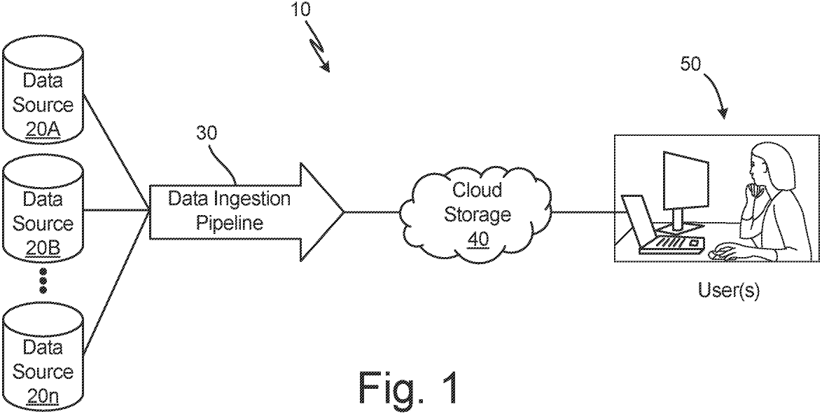

In contrast, the data ingestion pipeline described herein is metadata-driven because the process is based on abstracting away specifics due to common points that would be present in a number of separate pipelines for ingesting data from a set of data sources. For example, the common point for each pipeline when ingesting data from a set of data sources into one cloud-based data lake would be the shared destination (the data lake). Accordingly, the specifics of each data source can be abstracted away in the overall pipeline template. Information that enables identifying and connecting to each data source can be stored separately as metadata that corresponds to the data sources. The relevant metadata can be supplied to parameters in the pipeline to ingest data from specific data sources to the shared data lake. The data ingestion pipeline system disclosed herein and corresponding methods are described below with reference to FIGS. 1-8.

FIG. 1 is a simplified schematic diagram of data pipeline system 10 for ingesting data from various data sources into cloud storage. Data pipeline system 10 includes data sources 20A-20n (“n” is used herein as an arbitrary integer to indicate any number of the referenced component), data ingestion pipeline 30, cloud storage 40, and user(s) 50. System 10 can, for example, be based in Azure Data Factory or any similar platform.

Data sources 20A-20n are stores or collections of electronic data. Data sources 20A-20n can be relational, non-relational, or other data storage types. In some examples, data sources 20A-20n can be databases, such as Oracle databases, Azure SQL databases, or any other type of database. In some examples, data sources 20A-20n can be data lakes. In other examples, data sources 20A-20n can be SharePoint lists or flat file types, such as Excel spreadsheets. In yet other examples, data sources 20A-20n can be any suitable store of electronic data. Each of data sources 20A-20n can be the same type of data source or can be different types of data sources. In some examples, there can be groups of data sources 20A-20n with the same data source type. Further, although three data sources 20A-20n are depicted in FIG. 1, it should be understood that data pipeline system 10 can include any number of data sources 20A-20n, including more or fewer data sources 20A-20n. System 10 can, in principle, include a large and scalable number of data sources 20A-20n.

Data located in data sources 20A-20n can be structured (e.g., rows and columns in a relational database), unstructured, or semi-structured. In some examples, data sources 20A-20n store business data, such as employee information, customer information, sales information, financial information, etc., for an organization. In other examples, data sources 20A-20n store any type of electronic data. Each of data sources 20A-20n can store a same or different type of data.

Data ingestion pipeline 30 is a logical organization or template for a computer device (e.g., including software and hardware) that encapsulates one or more activities for ingesting data from data sources 20A-20n. In other words, data ingestion pipeline 30 is a framework that defines an ordered sequence of activities for moving data from data sources 20A-20n to a destination data store (e.g., cloud storage 40). Pipeline 30 can, for example, represent steps associated with an extract-transform-load (ETL) procedure or, in other examples, an extract-load-transform (ELT) procedure. Individual activities of pipeline 30 may have dependencies on other activities or may be nested within other activities and may be executed in parallel or in series, depending on the configuration of pipeline 30. Activities of pipeline 30 may also define loops for iterating through some or all of the activities. In some examples, pipeline 30 represents an overarching pipeline framework that includes multiple iterations or versions of the same sequence of activities (i.e., multiple subset pipelines nested within pipeline 30). For example, pipeline 30 can include the same sequence of activities organized into multiple iterations or versions based on a data source type of data sources 20A-20n. That is, pipeline 30 can include a separate subset pipeline for each data source type of data sources 20A-20n. Pipeline 30 provides a means for managing all the activities together as a set instead of individually managing each activity. For example, pipeline 30 can be scheduled or deployed itself, rather than separately deploying each pipeline activity. Each individual instance of deploying data ingestion pipeline 30 can be the same or different depending on what data should be obtained from which ones of data sources 20A-20n.

Cloud storage 40 is a destination data store for data ingested from data sources 20A-20n via pipeline 30. Cloud storage 40 can be located remotely from data sources 20A-20n. Cloud storage 40 can be, for example, a data lake. In some examples, cloud storage 40 stores raw copies of source data from data sources 20A-20n. In some examples, cloud storage 40 can also store transformed data to be used for tasks such as reporting, visualization, analytics, machine learning, etc. One or more users 50, such as data engineers, data scientists, or any other users, can connect to cloud storage 40 to access and use data that is stored within cloud storage 40.

In general, each of data sources 20A-20n, components of data ingestion pipeline 30, cloud storage 40, and user(s) 50 can be remote from each other. Individual ones of data sources 20A-20n can also be remote from each other. For example, individual data sources 20A-20n can be “on-premises” data sources (e.g., within an organization’s data centers) or “cloud” data sources (e.g., available using cloud services from vendors such as Amazon, Microsoft, or Google). Similarly, data ingestion pipeline 30 can be wholly or partially cloud-based. Wholly or partially cloud-based data ingestion pipeline 30 can be available from a same or different cloud service as one or more data sources 20A-20n in examples where the one or more data sources 20A-20n is also cloud-based. Cloud storage 40 can be available from a same or different cloud service as a wholly or partially cloud-based data ingestion pipeline 30. Cloud storage 40 can also be available from a same or different cloud service as one or more data sources 20A-20n in examples where the one or more of data sources 20A-20n is also cloud-based. Moreover, one or more activities of data ingestion pipeline 30 may not be executed in a fixed location, i.e., one or more activities of data ingestion pipeline 30 can be executed in different locations (e.g., on different processors).

Instead of requiring separate pipelines to be written and maintained for each individual data source from which data will be ingested, system 10 includes one overarching data ingestion pipeline or pipeline template (pipeline 30) that can accommodate connections to any number, including very large numbers, of data sources 20A-20n. Because data ingestion pipeline 30 can accommodate any number of data sources 20A-20n, system 10 is relatively easy to scale based on a particular organization’s data ingestion needs. That is, regardless of the exact number of data sources 20A-20n an organization may have, the organization can apply pipeline 30 to connect to and ingest data from all of data sources 20A-20n, rather than writing separate pipelines for each of data sources 20A-20n. This scalability allows system 10 to accommodate larger or smaller data aggregation tasks, as needed. Moreover, system 10 is a simplified system for data aggregation compared to traditional approaches because it can greatly reduce the time needed from developers to establish and maintain connections to an organization’s data sources. System 10, including pipeline 30, can also be relatively easier to monitor and maintain once it is deployed because system 10 is centralized, meaning that ingested data from data sources 20A-20n flows through the same pipeline 30, and information (about system status, performance, etc.) can all be obtained from one centralized place.

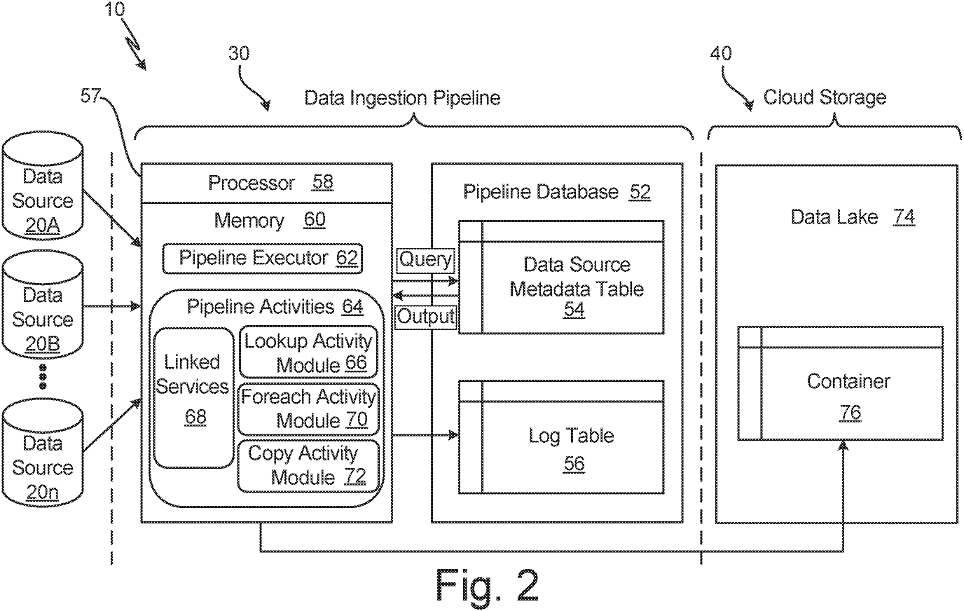

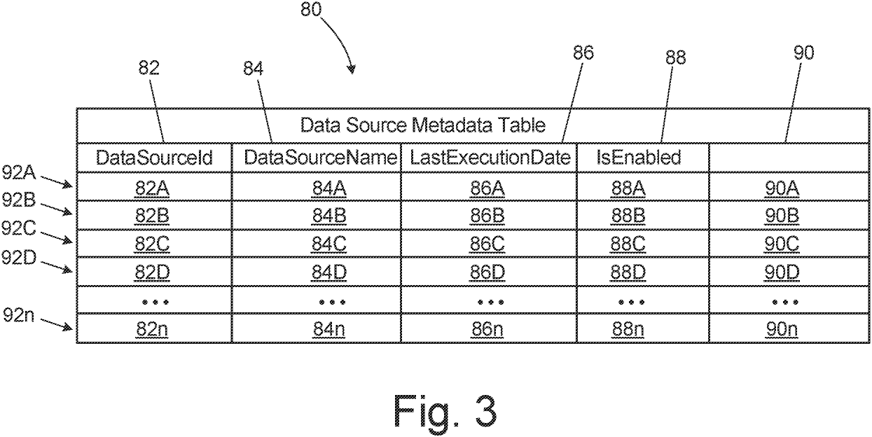

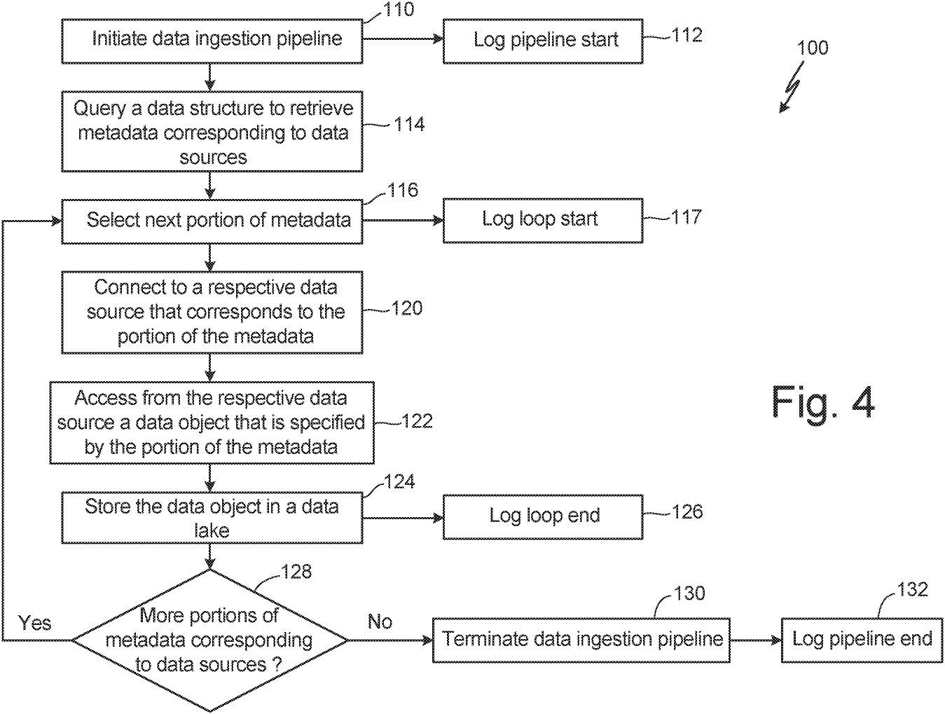

FIGS. 2-4 will be described together. FIG. 2 is a schematic block diagram showing details of data pipeline system 10. FIG. 3 is a simplified table of illustrative data source metadata. FIG. 4 is a process flowchart illustrating steps 110-132 of process 100 for ingesting data from various data sources into cloud storage.

Data pipeline system 10 includes data sources 20A-20n, data ingestion pipeline 30, and cloud storage 40, as described above with reference to FIG. 1. Data ingestion pipeline 30 further includes pipeline database 52 (including data source metadata table 54 and log table 56) and computer 57. Computer 57 includes processor 58, memory 60, pipeline executor 62, and pipeline activities module 64, which includes lookup activity module 66, linked services module 68, foreach activity module 70, and copy activity module 72. Cloud storage 40 further includes data lake 74, which includes container 76.

Database 52 is a pipeline database for storing data source metadata table 54 and log table 56. In some examples, database 52 is a SQL database. In some examples, database 52 is a cloud-based Azure SQL database. Database 52 stores data source metadata table 54 such that metadata table 54 can be queried during a runtime of data ingestion pipeline 30 (i.e., an instance of executing data ingestion pipeline 30). Although metadata table 54 and log table 56 are shown in FIG. 2 as data structures that are stored on shared database 52, it should be understood that all or part of metadata table 54 and log table 56 can be stored on separate databases. For example, metadata table 54 can be stored on a first database (e.g., database 52) and log table 56 can be stored on a second database.

Metadata table 54 includes metadata that corresponds to each of data sources 20A-20n (i.e., a set of data that describes each of data sources 20A-20n and/or data objects stored therein). Metadata from data sources 20A-20n is entered into metadata table 54 prior to a runtime of data ingestion pipeline 30. Metadata table 54 is shown in FIG. 2 as a table but can also be a list or any data structure suitable for storing data in an organized manner. Metadata from each of data sources 20A-20n can be organized in metadata table 54 into clusters or portions (e.g., rows) according to the respective one of data sources 20A-20n to which the metadata corresponds.

Referring now to FIG. 3, metadata table 80 is an example of metadata table 54 (FIG. 2). Metadata table 80 includes columns 82, 84, 86, 88, and 90, which respectively include values 82A-82n, 84A-84n, 86A-86n, 88A-88n, and 90A-90n, organized in corresponding rows 92A-92n. Each column 82, 84, 86, 88, 90 corresponds to a shared attribute of the values in metadata table 80. Specifically, column 82 corresponds to the attribute “DataSourceId,” which represents an identification or identity of each one of data sources 20A-20n. Column 84 corresponds to the attribute “DataSourceName,” which represents a name of each one of data sources 20A-20n. Column 86 corresponds to the attribute “LastExecutionDate,” which represents a date (and/or time) that each one of data sources 20A-20n was last executed. Column 88 corresponds to the attribute “IsEnabled,” which represents an indication whether each one of data sources 20A-20n is enabled. Column 90 can correspond to any additional attribute, such as a data source type, a data object name, a last modified date, or other attribute. Moreover, although metadata table 80 is shown in FIG. 3 to include five columns, other examples can include more or fewer columns. More generally, metadata table 80 can include any suitable number of columns depending on the desired attributes to include to enable identifying and connecting to each of data sources 20A-20n. Taken together, the attributes represented by columns 82, 84, 86, 88, and 90 (and any additional columns of metadata table 80) can be information (i.e., metadata) about data sources 20A-20n that enables identifying and connecting to each one of data sources 20A-20n. Any of the columns, and particularly the attributes “LastExecutionDate” and “IsEnabled,” can be periodically updated in metadata table 80 with information from data sources 20A-20n to ensure that the information (i.e., the values) contained in metadata table 80 is current.

Values in metadata table 80 can have different data types, e.g., varchar, date, int, bit, etc. Values contained within the same column (e.g., one of columns 82, 84, 86, 88, 90) can all have the same data type. For example, values 82A-82n in column 82 can all have the data type varchar, and values 88A-88n in column 88 can have a different data type, such as bit. Valid data types for the values in metadata table 80 can depend on a schema of the database (e.g., database 52) where metadata table 80 (or a different data structure containing metadata corresponding to data sources 20A-20n) is stored.

Each of rows 92A-92n corresponds to a respective one of data sources 20A-20n. Metadata table 80 can include any suitable number of rows 92A-92n. In some examples, a total number of rows in metadata table 80 can be equal to a total number of data sources 20A-20n. For example, row 92A is a relatively first row of metadata table 80, and row 92A can correspond to a first one of data sources 20A-20n (e.g., data source 20A). (“First” indicating that there are no rows of metadata table 80 before row 92A but not indicating any particular order of connecting to or retrieving information corresponding to data sources 20A-20n.) Row 92A includes values 82A, 84A, 86A, 88A, and 90A, which correspond, respectively, to each attribute (columns 82, 84, 86, 88, and 90) for the first one of data sources 20A-20n. Accordingly, value 82A is an identification of the first one of data sources 20A-20n, value 84A is a name of the first one of data sources 20A-20n, value 86A is a last execution date of the first one of data sources 20A-20n, and value 86A is an indication whether the first one of data sources 20A-20n is enabled. Values 82A, 84A, 86A, 88A, and 90A of row 92A, when taken together, can enable identifying and connecting to the first one of data sources 20A-20n.

Similarly, row 92B can correspond to a second one of data sources 20A-20n (e.g., data source 20B). Row 92B includes values 82B, 84B, 86B, 88B, and 90B, which correspond, respectively, to each attribute (columns 82, 84, 86, 88, and 90) for the second one of data sources 20A-20n. Accordingly, value 82B is an identification of the second one of data sources 20A-20n, value 84B is a name of the second one of data sources 20A-20n, value 86B is a last execution date of the second one of data sources 20A-20n, and value 86B is an indication whether the second one of data sources 20A-20n is enabled. Values 82B, 84B, 86B, 88B, and 90B of row 92B, when taken together, can enable identifying and connecting to the second one of data sources 20A-20n.

Row 92C can correspond to a third one of data sources 20A-20n (e.g., data source 20C, not shown). Row 92C includes values 82C, 84C, 86C, 88C, and 90C, which correspond, respectively, to each attribute (columns 82, 84, 86, 88, and 90) for the third one of data sources 20A-20n. Accordingly, value 82C is an identification of the third one of data sources 20A-20n, value 84C is a name of the third one of data sources 20A-20n, value 86C is a last execution date of the third one of data sources 20A-20n, and value 86C is an indication whether the third one of data sources 20A-20n is enabled. Values 82C, 84C, 86C, 88C, and 90C of row 92C, when taken together, can enable identifying and connecting to the third one of data sources 20A-20n.

Row 92D can correspond to a fourth one of data sources 20A-20n (e.g., data source 20D, not shown). Row 92D includes values 82D, 84D, 86D, 88D, and 90D, which correspond, respectively, to each attribute (columns 82, 84, 86, 88, and 90) for the fourth one of data sources 20A-20n. Accordingly, value 82D is an identification of the fourth one of data sources 20A-20n, value 84D is a name of the fourth one of data sources 20A-20n, value 86D is a last execution date of the fourth one of data sources 20A-20n, and value 86D is an indication whether the fourth one of data sources 20A-20n is enabled. Values 82D, 84D, 86D, 88D, and 90D of row 92D, when taken together, can enable identifying and connecting to the fourth one of data sources 20A-20n.

Row 92n is a relatively last or final row of metadata table 80, and row 92n can correspond to a relatively final one of data sources 20A-20n (e.g., data source 20n). (“Last” or “final” indicating that there are no additional rows of metadata table 80 after row 92n but not indicating any particular order of connecting to or retrieving information corresponding to data sources 20A-20n.) Row 92n includes values 82n, 84n, 86n, 88n, and 90n, which correspond, respectively, to each attribute (columns 82, 84, 86, 88, and 90) for the final one of data sources 20A-20n. Accordingly, value 82n is an identification of the final one of data sources 20A-20n, value 84n is a name of the final one of data sources 20A-20n, value 86n is a last execution date of the final one of data sources 20A-20n, and value 86n is an indication whether the final one of data sources 20A-20n is enabled. Values 82n, 84n, 86n, 88n, and 90n of row 92n, when taken together, can enable identifying and connecting to the final one of data sources 20A-20n.

Referring again to FIG. 2, computer 57 includes processor 58 and memory 60. Although processor 58 and memory 60 are illustrated in FIG. 2 as being separate components of a single computer device, it should be understood that in other examples, processor 58 and memory 60 can be distributed among multiple connected devices. In yet other examples, memory 60 can be a component of processor 58. Processor 58 is configured to implement functionality and/or process instructions within data pipeline system 10. For example, processor 58 can be capable of processing instructions stored in memory 60. Examples of processor 58 can include one or more of a processor, a microprocessor, a controller, a digital signal processor (DSP), an application specific integrated circuit (ASIC), a field-programmable gate array (FPGA), or other equivalent discrete or integrated logic circuitry.

Memory 60 can be configured to store information before, during, and/or after operation of data pipeline system 10. Memory 60, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 60 can be entirely or partly temporary memory, meaning that a primary purpose of memory 60 is not long-term storage. Memory 60, in some examples, is described as volatile memory, meaning that memory 60 does not maintain stored contents when power to devices (e.g., computer 57) is turned off. Examples of volatile memories can include random access memories (RAM), dynamic random access memories (DRAM), static random access memories (SRAM), and other forms of volatile memories. Memory 60, in some examples, also includes one or more computer-readable storage media. Memory 60 can be configured to store larger amounts of information than volatile memory. Memory 60 can further be configured for long-term storage of information. In some examples, memory 60 includes non-volatile storage elements. Examples of such non-volatile storage elements can include magnetic hard discs, optical discs, flash memories, or forms of electrically programmable memories (EPROM) or electrically erasable and programmable (EEPROM) memories.

Memory 60 is encoded with instructions that are executed by processor 58. For example, memory 60 can be used to store program instructions for execution by pipeline executor 62 on processor 58. In some examples, memory 60 is used by software or applications running on processor 58, e.g., pipeline executor 62, to temporarily store information during program execution.

Pipeline executor 62 is a compute infrastructure or environment where individual activities of pipeline activities module 64 (e.g., lookup activity module 66, linked services module 68, foreach activity module 70, and copy activity module 72) are executed directly or dispatched for execution. Pipeline executor 62 can also interact with other software, such as other programs or applications within the Microsoft Azure platform. Pipeline executor 62 can be a program that runs on processor 58 itself. In such examples, pipeline executor 62 can be either self-hosted (i.e., by an organization using an on-premises machine or virtual machine inside a private network) or hosted on a cloud-based platform, such as within Azure Data Factory. In other examples, pipeline executor 62 can dispatch one or more of the individual activities of pipeline activities module 64 to be run in a different location (i.e., on a different processor). In some examples, activities can be dispatched to compute environments that are local to ones of data sources 20A-20n when a connection will be made to that respective one of data sources 20A-20n during a runtime of data ingestion pipeline 30.

Pipeline activities module 64 is an ordered sequence of activities that makes up the functionality of data ingestion pipeline 30. Lookup activity module 66, linked services module 68, foreach activity module 70, and copy activity module 72 are functional units or activity sub-modules (collectively, the “activity sub-modules”) of pipeline activities module 64 within data ingestion pipeline 30. The activity sub-modules can correspond to distinct devices within data ingestion pipeline 30 or can be functional modules not corresponding to specific separate hardware. That is, although pipeline activities module 64 and each of lookup activity module 66, linked services module 68, foreach activity module 70, and copy activity module 72 are illustrated as distinct functional modules executed within shared hardware, e.g., by processor 58 or on other shared hardware, any or all of the activity sub-modules can correspond to separate external logic-capable devices that include internal memory. For example, copy activity module 72 would not be executed by processor 58 when copy activity module 72 is dispatched by pipeline executor 62 to a compute environment that is local to one of data sources 20A-20n. In the most general case, however, each of pipeline activities module 64 and the activity sub-modules can be any logic level modules communicatively coupled to pipeline executor 62 on processor 58 and coupled to each other only or primarily via pipeline executor 62.

At a runtime of data ingestion pipeline 30, pipeline executor 62 executes the activity sub-modules of pipeline activities module 64 according to a configuration (e.g., a JSON file or files) retrieved, for example, from memory 60. The configuration defines the sequence or order— and any dependencies, loops, or specifications—of the activity sub-modules within pipeline activities module 64. In some examples, the configuration of pipeline activities module 64 can include multiple defined sequences of the activity sub-modules arranged into subset pipelines within pipeline 30. In some examples, there can be a defined sequence of the activity sub-modules that corresponds to each data source type (e.g., Oracle database, Azure SQL database, Azure Blob storage, etc.) of data sources 20A-20n (i.e., there can be a separate subset pipeline for each data source type). Each of the activity sub-modules can be represented in a portion of the configuration as a block of JSON that contains its respective properties. The configuration (JSON) file is parsed by pipeline executor 62 to perform an activity corresponding to one of the activity sub-modules. In some examples, the activity sub-modules can be organized into the configuration by accessing, arranging, and modifying template JSON blocks from a library of pre-defined pipeline activities. In other examples, pipeline executor 62 can include a program or script that performs the activities associated with each of the activity sub-modules in the defined order (rather than relying on a configuration file).

Pipeline activities module 64 can also be configured so that pipeline executor 62 logs and/or reports errors and statuses (or session information) associated with the activity sub-modules during a runtime of pipeline 30. For example, logs can be generated for a start and end of pipeline 30, a start and end of any loop iterations, or other points of pipeline 30. In some examples, logs can be generated that are specific to the activity performed for a given one of the activity sub-modules (e.g., a copy activity can generate a log of column names that were copied). Any logs generated during a runtime of pipeline 30 can be stored in log table 56. Log table 56 can be queried to return performance information about each step of pipeline 30 or about pipeline 30 overall. For example, performance information that might be determined from the logs in log table 56 can include how long it took to run pipeline 30 overall, how long it took to perform each iteration of a loop, etc. In some examples, pipeline executor 62 can also generate or trigger notifications associated with errors or statuses, such as a start or end, of the activity sub-modules or pipeline 30. For example, pipeline executor 62 can generate or trigger an email to be sent when a runtime of pipeline 30 is completed. In some examples, pipeline executor 62 can be integrated with another application for sending emails, such as an Azure Logic App.

A pipeline run or an instance of pipeline execution for pipeline 30 (or of a nested subset pipeline within pipeline 30) can be initiated via pipeline executor 62 by passing arguments (values) to parameters or placeholders that are defined in pipeline 30. Arguments can be passed manually or by defining pipeline triggers. Pipeline triggers can include scheduling pipeline 30 or activities (e.g., activities corresponding to lookup activity module 66, linked services module 68, foreach activity module 70, and/or copy activity module 72) of pipeline 30 to be performed automatically after a defined period elapses or after a trigger event occurs. Trigger events can include, for example, updates to a dataset, such as an update to the data stored in one of data sources 20A-20n. In some examples, arguments passed to initiate pipeline 30 can also be passed to a particular activity sub-module or a pipeline trigger can be linked to a particular activity sub-module.

Lookup activity module 66 is a first functional unit of pipeline activities module 64. Lookup activity module 66 can receive an argument indicating a dataset or a part of a dataset to return. Lookup activity module 66 is configured to read and return the content of the indicated dataset, such as a configuration file, table, or other data structure (e.g., metadata table 54, 80), from the indicated data store (e.g., database 52). Lookup activity module 66 can return the result of a query or a stored procedure. In one example, lookup activity module 66 queries metadata table 80 to retrieve metadata corresponding to one or more of data sources 20A-20n.

The argument passed to lookup activity module 66 and the query of metadata table 80 can specify which rows 92A-92n (i.e., which data sources 20A-20n) and/or which columns 82, 84, 86, 88, 90 (i.e., which attributes) of metadata table 80 to retrieve values from. In some examples, lookup activity module 66 can retrieve the entire set of values (all rows and all columns) from metadata table 80 so that an entire set of metadata corresponding to all of data sources 20A-20n is retrieved. In other examples, lookup activity module 66 can retrieve only portions of the metadata that correspond to respective ones or more of data sources 20A-20n (one or more rows) or certain attributes (one or more columns). For example, lookup activity module 66 can retrieve a portion of the metadata that corresponds to ones of data sources 20A-20n that have the same data source type. In some examples, lookup activity module 66 can retrieve a portion of the metadata that corresponds to a respective one of data sources 20A-20n (one row).

Depending on a number or selection of rows to be returned (e.g., from metadata table 80), lookup activity module 66 can have multiple instances within pipeline 30. In some examples, the multiple instances of lookup activity module 66 can be run in parallel such that lookup activity module 66 can essentially split off and start two or more nearly identical instances of the subsequent activity sub-modules of pipeline 30 (i.e., nested subset pipelines within pipeline 30). In other examples, pipeline 30 can be configured (e.g., via the configuration corresponding to pipeline activities module 64 and retrieved by pipeline executor 62) to loop over the lookup activity until the desired number of rows is retrieved.

An output of lookup activity module 66 can be, for example, a single value corresponding to a particular row and column combination (one attribute of one data source 20A-20n), a set of values corresponding to a particular one of data sources 20A-20n, or an array of values corresponding to multiple data sources 20A-20n and multiple attributes. For example, the array of values can correspond to a group of data sources 20A-20n that have the same data source type. The output of lookup activity module 66 can be in a list format that maintains the row and column information corresponding to metadata table 80. Accordingly, the output list includes portions of metadata from metadata table 80 that correspond to respective ones or more of data sources 20A-20n. Further, the output of lookup activity module 66 can be consumed, or operated on, in a subsequent activity sub-module of pipeline activities module 64 within pipeline 30.

Foreach activity module 70 is a second functional unit of pipeline activities module 64. Foreach activity module 70 defines a loop of repeating actions within pipeline 30. That is, foreach activity module 70 organizes subsequent activity sub-modules to be executed in a loop. Foreach activity module 70 can be considered an overarching activity sub-module with further nested ones of the activity sub-modules. In general, foreach activity module 70 is used to iterate over a dataset. Iterations within foreach activity module 70 can be performed concurrently (in parallel) or in series, depending on constraints of system 10 (e.g., hardware constraints, which may be accounted for in the configuration of pipeline activities module 64).

Foreach activity module 70 depends on lookup activity module 66, and, therefore, lookup activity module 66 is configured to precede foreach activity module 70. The output from lookup activity module 66 makes up a dataset over which foreach activity module 70 will iterate or operate on. For example, foreach activity module 70 can receive the output list from lookup activity module 66 that includes portions (e.g., rows) of metadata from metadata table 80 corresponding to respective ones or more of data sources 20A-20n.

Each iteration within foreach activity module 70 can correspond to a row in the output list from lookup activity module 66, and, therefore, can correspond to one of rows 92A-92n of metadata table 80 and a corresponding one of data sources 20A-20n. At a start of each iteration, foreach activity module 70 can identify or move to a next row in the output list. Subsequent activity sub-modules can be linked to, or associated with, foreach activity module 70 identifying or moving to a row in the output list. During a first iteration of foreach activity module 70, foreach activity module 70 can identify or move to a first row in the output list, which can correspond to a first one of data sources 20A-20n. For example, the first row in the output list can correspond to row 92A of metadata table 80 and data source 20A. After foreach activity module 70 identifies the first row in the output list, a subsequent activity sub-module (e.g., copy activity module 72) can be deployed for the first row. Foreach activity module 70 then identifies or moves to the next row in the output list, which can correspond to a second one of data sources 20A-20n. For example, the second row in the output list can correspond to row 92B of metadata table 80 and data source 20B. After foreach activity module 70 identifies the second row in the output list, the subsequent activity sub-module (e.g., copy activity module 72) can be deployed for the second row. The iteration process is repeated until there are no remaining rows in the output list. Foreach activity module 70 can have any number of iterations depending on the number of rows in the output list from lookup activity module 66.

Copy activity module 72 is a third functional unit of pipeline activities module 64. Copy activity module 72 is also a nested functional unit within foreach activity module 70. An instance of copy activity module 72 is deployed for each iteration caused by foreach activity module 70. In general, copy activity module 72 reads data from a data source (e.g., one of data sources 20A-20n) and writes the data to a destination or sink data store (e.g., data lake 74). For each iteration of foreach activity module 70, copy activity module 72 establishes a connection to the respective one of data sources 20A-20n that corresponds to the row or portion of the dataset (e.g., the output list from lookup activity module 66) that is selected by foreach activity module 70. For example, when foreach activity module 70 goes to the first row in the output list, which can correspond to row 92A of metadata table 80 and data source 20A, copy activity module 66 can receive values 82A, 84A, 86A, 88A, and 90A from row 92A to identify and connect to corresponding data source 20A. This process is repeated for each instance of copy activity module 72 that is triggered by an iteration within foreach activity module 70, such that the instances of copy activity module 72 collectively identify and connect to each of the one or more data sources 20A-20n that correspond to the portions of the metadata in the output list from lookup activity module 66. As will be described in greater detail below, the connection to the respective one of data sources 20A-20n and to data lake 74 can be made via linked services module 68.

A given instance of copy activity module 72 accesses and reads a data object from the respective one of data sources 20A-20n. The data object to be read by copy activity module 72 can be specified by the portion of the metadata from metadata table 80 that corresponds to the respective one of data sources 20A-20n. That is, one or more of the values received by copy activity module 72 from the row in the output list can specify the data object within the respective one of data sources 20A-20n. In some examples, the one or more of the values received by copy activity module 72 from the row in the output list can specify multiple data objects to access and read within the respective one of data sources 20A-20n.

Once the data object has been accessed, copy activity module 72 reads the data object and writes (i.e., copies) the data object to data lake 74, or any suitable destination data store that is specified in the properties of copy activity module 72, to store the data object in data lake 74. In some examples, storing the data object in data lake 74 can involve creating a copy of the data object from the respective one of data sources 20A-20n and storing the copy of the data object in data lake 74. In some examples, copy activity module 72 can be configured to incrementally copy new, updated, or modified/changed portions of data from data sources 20A-20n. In such examples, metadata table 80 can include a column corresponding to a watermark value, an incrementing key, or a last modified date, such that copy activity module 72 receives the watermark value corresponding to the respective one of data sources 20A-20n. Copy activity module 72 can also be configured to retrieve an old watermark value for the respective one of data sources 20A-20n, e.g., stored from a previous instance of pipeline 30. If there is a change in the watermark value for the respective one of data sources 20A-20n, copy activity module 72 can load the data between the two watermark values as the data object to store in data lake 74. Similarly, copy activity module 72 can include a filter property to only load a data object from the respective one of data sources 20A-20n if the watermark value is more recent than a time a data object was last copied from that data source to data lake 74.

Additionally, copy activity module 72 can perform serialization/deserialization, compression/decompression, column mapping, etc. between reading the data object from the respective one of data sources 20A-20n and storing the data object in data lake 74. These additional processing steps can be used to convert the data object from the data source to a specific format for storage in data lake 74. In some examples, data objects are stored in data lake 74 in a Parquet format. In other examples, copy activity module 72 can copy the data object “as is” without performing any additional processing steps. Moreover, copy activity module 72 can map a data object from the respective one of data sources 20A-20n to its corresponding location data lake 74 based on the attributes or columns (e.g., columns 82, 84, 86, 88, 90) of metadata table 80.

Linked services module 68 is a fourth functional unit of pipeline activities module 64. Instances of linked services module 68 are deployed within pipeline 30 to make connections between components, such as data stores and/or computes, of system 10. The properties associated with each instance of linked services module 68 (e.g., as specified in the JSON configuration file) can define the connection information needed to connect between two components at a runtime of pipeline 30. Each instance of linked services module 68 is formatted for a particular data source type. For data stores, a connection via linked services module 68 can be based on standard properties of different data store types. Within pipeline 30, there can be separate instances of linked services module 68 that correspond to a connection between each one of data sources 20A-20n (of a particular data source type) and data lake 74 and to a connection to database 52.

Linked services module 68 can be parameterized or can have defined (i.e., pre-configured or hard-written) connections. A connection string of linked services module 68 can be parameterized based on the metadata from metadata table 80 (e.g., based on the output list from lookup activity module 66). More specifically, to form a connection to a respective one of data sources 20A-20n, or between a respective one of data sources 20A-20n and data lake 74, an instance of linked services module 68 can be parameterized based on the portion of the metadata that corresponds to the respective one of data sources 20A-20n. That is, one or more of the values (e.g., values 82A-82n, 84A-84n, 86A-86n, 88A-88n, and 90A-90n of metadata table 80) corresponding to attributes of the respective one of data sources 20A-20n can be injected into the connection string. The value injected into the connection string can represent, e.g., the data source name or another attribute of the respective one of data sources 20A-20n. This instance of linked services module 68 can be associated with (or triggered by) a corresponding instance of copy activity module 72 for the respective one of data sources 20A-20n. On the other hand, known or set connections, such as to database 52 for retrieving metadata from metadata table 54, 80, can be defined or pre-configured in the properties of linked services module 68. For example, the configuration (JSON) file for the instance of linked services module 68 that forms the connection to database 52 can directly include the connection information needed to connect to database 52. The instance of linked services module 68 that forms the connection to database 52 can be associated with (or triggered by) lookup activity module 66. Similarly, linked services module 68 can also be pre-configured with the connection information needed to connect to data lake 74 (because data lake 74 is the common sink location for data ingested via pipeline 30).

Data lake 74 is a destination or sink data store associated with data ingestion pipeline 30 in system 10. Data lake 74 can be a cloud-based (i.e., remote) data lake. Data objects copied from the one or more data sources 20A-20n are stored in data lake 74. Data lake 74 can further include container 76. Container 76 can represent a grouping or data structure within data lake 74 for organizing and storing data objects copied from ones of data sources 20A-20n. The data objects can be stored in data lake 74 in any suitable format. In some examples, the data objects are stored in the Parquet format. Data objects that are stored in data lake 74 can be readily accessible, for example, for business analytics purposes or other purposes. Moreover, a file name of a respective data object in data lake 74 can be based on the portion of the metadata from metadata table 80 that corresponds to the respective one of data sources 20A-20n from which the data object was accessed. In some examples, the file name can include values corresponding to the data source identification (e.g., column 82, one of values 82A-82n), the data source name (e.g., column 84, one of values 84A-84n), and/or the data object name in the data source. More generally, the file name can be based on the values from any one or more of columns 82, 84, 86, 88, and 90 that correspond to the respective one of data sources 20A-20n from which the data object was accessed.

Process 100 for ingesting data from data sources 20A-20n into cloud storage 40, as illustrated in FIG. 4, will be described with reference to components of system 10 described above (FIGS. 1-3). Process 100 begins by initiating data ingestion pipeline 30 (step 110). As described above, pipeline 30 can be initiated manually or automatically based on a trigger. A start of data ingestion pipeline 30 is logged (step 112) when pipeline 30 is initiated, and this log can be stored in log table 56.

At step 114, metadata table 80 is queried, e.g., by lookup activity module 66, to retrieve metadata corresponding to one or more of data sources 20A-20n. An ordered sequence of activities to be performed for the one or more data sources 20A-20n can correspond to steps 116 to 126. At step 116, the next portion of the retrieved metadata is selected, e.g., by foreach activity module 70. A portion of the metadata can be a row (e.g., rows 92A-92n) of metadata table 80 that corresponds to a respective one of data sources 20A-20n. During a first iteration or loop of process 100, the “next” portion of the metadata is a first portion or first row. A start of a first loop is logged once the respective portion of the metadata is selected (or before forming the connection to the respective one of data sources 20A-20n) (step 117). Subsequent iterations of the loop (starting at step 116) can be logged as second, third, etc. loop starts.

Within an iteration of the loop, a respective one of data sources 20A-20n that corresponds to the portion of the metadata is connected to, e.g., by linked services module 68 (step 120). At step 122, a data object that is specified by the portion of the metadata is accessed from the respective one of data sources 20A-20n. At step 124, the data object is stored in data lake 74. After the data object is stored in data lake 74, an end of the respective loop iteration (e.g., first, second, third, etc.) is logged (step 126). Both the loop start and the loop end logs can be stored in log table 56 for each iteration of the loop.

At step 128, a decision is made within foreach activity module 70 to determine if there are more portions (e.g., more rows) of metadata remaining that correspond to additional ones of data sources 20A-20n. If there are more rows (Yes), the loop iterates again from step 116. If there are not more rows (No), the loop is completed and data ingestion pipeline 30 is terminated (step 130). An end of pipeline 30 can be logged (step 132) after the sequence of activities has been performed for each of the one or more data sources 20A-20n, and this log can also be stored in log table 56.

As described above, instead of requiring separate pipelines to be written and maintained for each individual data source from which data will be ingested, system 10 includes one overarching data ingestion pipeline or pipeline template (pipeline 30) that can accommodate connections to any number, including very large numbers, of data sources 20A-20n. Because data ingestion pipeline 30 can accommodate any number of data sources 20A-20n, system 10 is relatively easy to scale based on a particular organization’s data ingestion needs. That is, regardless of the exact number of data sources 20A-20n an organization may have, the organization can apply pipeline 30 to connect to and ingest data from all of data sources 20A-20n, rather than writing separate pipelines for each of data sources 20A-20n. This scalability allows system 10 to accommodate larger or smaller data aggregation tasks, as needed.

System 10 is readily scalable because the information required to identify and connect to any one of data sources 20A-20n is contained centrally within metadata table 54, 80. Steps (e.g., the activities of lookup activity module 66, linked services module 68, foreach activity module 70, and copy activity module 72) of pipeline 30 can all be configured based on metadata table 54, 80. That is, metadata table 54, 80 is a common point that ties all of the steps of pipeline 30 together because each of the activity sub-modules refers to metadata from metadata table 54, 80. Accordingly, the information that enables identifying and connecting to each of data sources 20A-20n can be consolidated in metadata table 54, 80 rather than spread out in the properties/configuration of each individual step of pipeline 30.

Moreover, system 10 is a simplified system for data aggregation compared to traditional approaches because it can greatly reduce the time needed from developers to establish and maintain connections to an organization’s data sources. System 10 including pipeline 30 can also be relatively easier to monitor and maintain once it is deployed because system 10 is centralized in that ingested data from data sources 20A-20n flows through the same pipeline 30, so information, about system status, performance, etc. can all be obtained from one centralized place.

Additionally, updates to system 10 that may be made based on changes to data sources 20A-20n, such as adding new data sources, removing data sources, updating the data stored in data sources 20A-20n, etc. can be accomplished via metadata table 54, 80. The respective portions (e.g., row or rows) of metadata table 54, 80 can be modified to reflect changes to data sources 20A-20n, rather than requiring changes to be made to individual pipeline configurations that were written for each data source. Thus, metadata table 54, 80 enables pipeline 30 and system 10 to be more flexible.

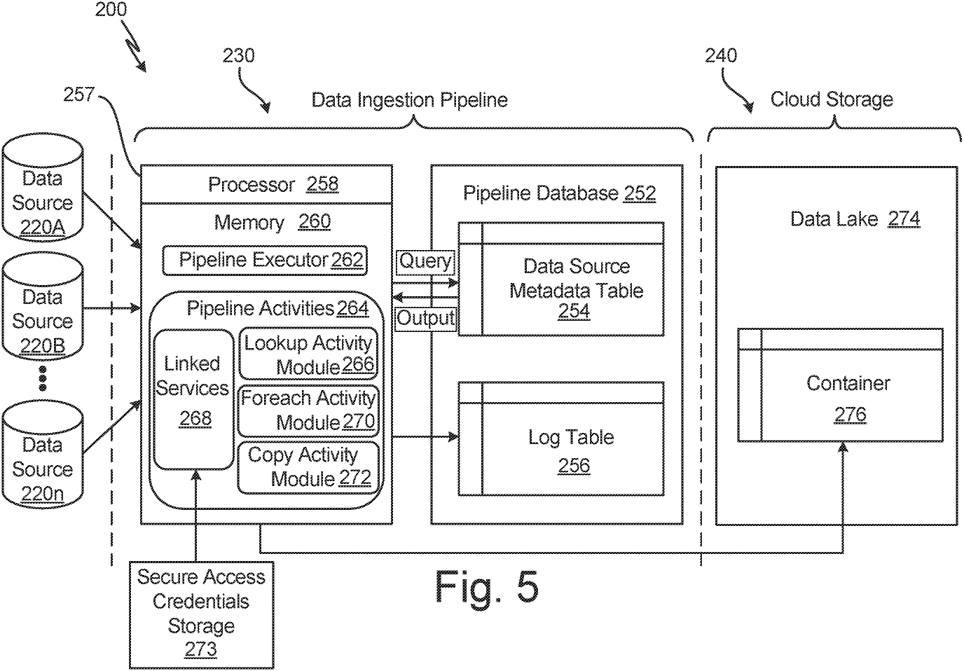

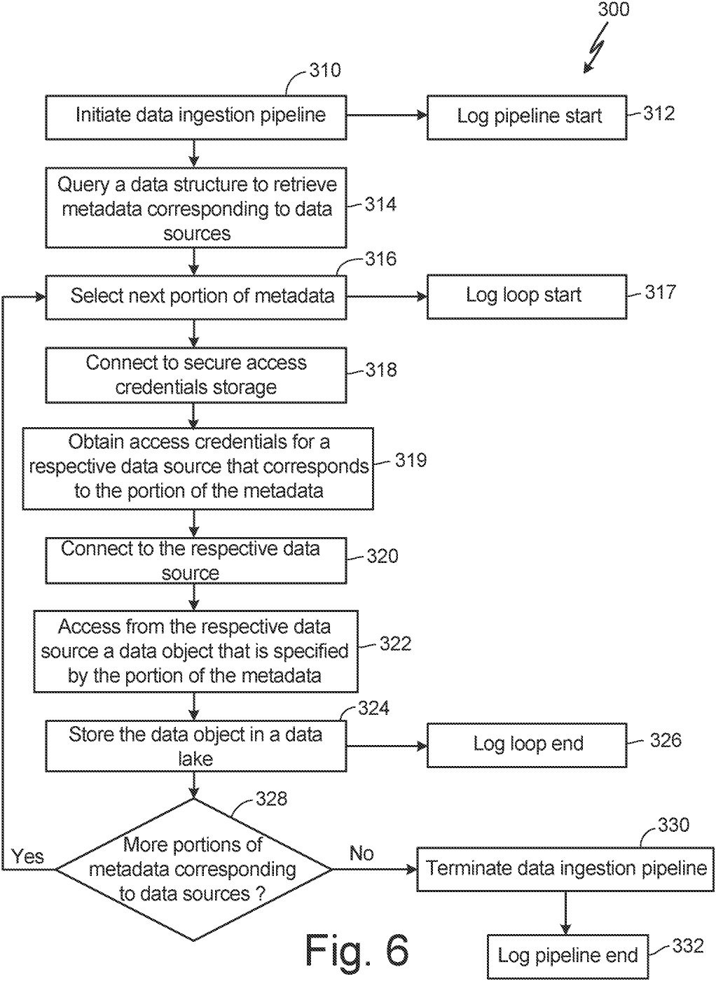

FIGS. 5 and 6 will be described together. FIG. 5 is a schematic block diagram showing details of data pipeline system 200 including secure access credentials storage 273. FIG. 6 is a process flowchart illustrating steps 310-332 of process 300 for ingesting data including steps for obtaining access credentials.

Data pipeline system 200 includes essentially the same components and function as described above with reference to data pipeline system 10 in FIGS. 2-4, except system 200 additionally includes secure access credentials storage 273. (Similar or identical components are given like designations with corresponding reference numbers that are increased by 200.) Secure access credentials storage 273 is a service, e.g., a software-as-a-service (SaaS), that securely stores and controls access to keys, passwords, certificates, or other any type of secure information. Secure access credentials storage 273 can be, for example, a cloud-based service such as Azure Key Vault. In system 200, secure access credentials storage 273 can securely store access credentials for data sources 220A-220n. Access credentials can include information such as a username and/or a password. The access credentials are tied to a key or secret associated with secure storage 273. Metadata table 254 can include a column, or attribute, corresponding to a name of the key or secret. To obtain the access credentials for connecting to a respective one of data sources 220A-220n, linked services module 268 can connect to secure access credentials storage 273 using the metadata value that specifies the name of the key or secret (i.e., a key value) for the respective one of data sources 220A-220n, the value having been retrieved as an output from lookup activity module 266 and passed to an iteration of copy activity module 272. Once the access credentials are obtained for the respective one of data sources 220A-220n, linked services module 268 can connect to the respective one of data sources 220A-220n using the access credentials.

Process 300 includes essentially the same steps as described above with reference to process 100 in FIG. 4, except process 300 additionally includes steps that correspond to secure access credentials storage 273. (Similar or identical steps are given like designations with corresponding reference numbers that are increased by 300.) Within an iteration of the loop (starting at step 316) and prior to connecting to one of data sources 220A-220n, linked services module 268 connects to secure access credentials storage 273 (step 318). At step 319, linked services module 268 obtains access credentials for the respective one of data sources 220A-220n that corresponds to the portion of the metadata selected by foreach activity module 270 in this iteration of the loop. Once access credentials have been obtained, linked services module 268 can connect to the respective on of data sources 220A-220n (step 320). The remaining steps of process 300 proceed as described above with respect to process 100 (FIG. 4).

In addition to the benefits of system 10 described above, system 200 (and process 300) including secure access credentials storage 273 allows an additional level of security to be built into the pipeline. This is another example of the flexibility enabled by utilizing metadata table 254 in system 200 because the additional level of security is enabled by storing keys or secrets as attributes in metadata table 254.

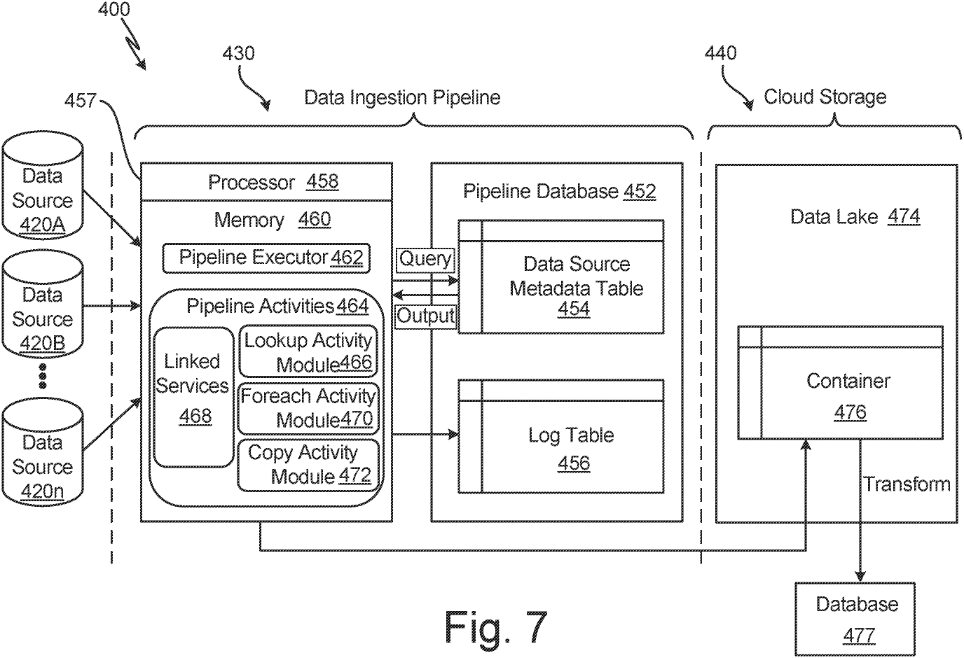

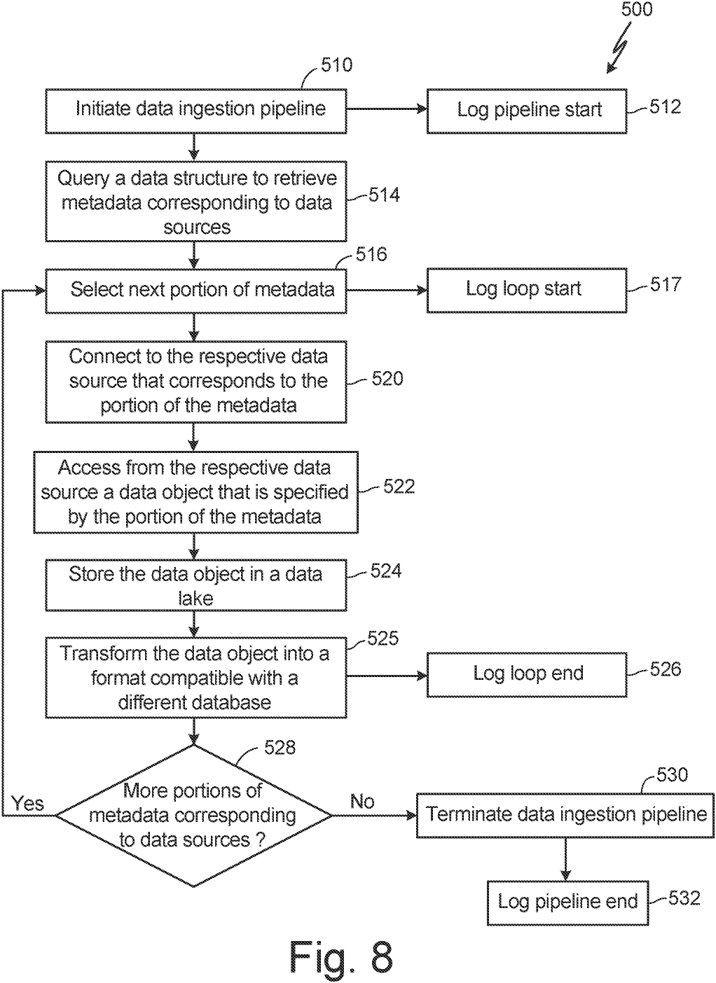

FIGS. 7 and 8 will be described together. FIG. 7 is a schematic block diagram showing details of data pipeline system 400 including additional database 477. FIG. 8 is a process flowchart illustrating steps 510-532 of process 500 for ingesting data including a step for transforming a data object.

Data pipeline system 400 includes essentially the same components and function as described above with reference to data pipeline system 10 in FIG. 1, except system 400 additionally includes database 477. (Similar or identical components are given like designations with corresponding reference numbers that are increased by 400.) Database 477 is a data store that is different from data lake 474. Database 477 can include a database schema that allows users to use a query language against data stored therein. For example, database 477 can be an Apache Hive data warehouse associated with the Apache Hadoop ecosystem. In some examples, data objects stored in data lake 474 can be transformed, or processed, into a different format and stored, or copied, into database 477. The transformation or processing step can transform data from data lake 474 (e.g., stored in a Parquet format) into a format that is compatible with database 477. The transformation or processing step can retain metadata corresponding to the respective one of data sources 420A-420n that is associated with the respective data object. In some examples, the data objects stored in data lake 474 can be processed using Databricks within Microsoft Azure.

Process 500 includes essentially the same steps as described above with reference to process 100 in FIG. 4, except process 500 additionally includes a step that corresponds to the additional database 477. (Similar or identical steps are given like designations with corresponding reference numbers that are increased by 500.) Within an iteration of the loop (starting at step 516) and after the respective data object is stored in data lake 474, the data object can be transformed into a format that is compatible with a different database (e.g., database 477) (step 525). Thus, instead of logging an end of the loop after the data object is stored in data lake 474 (step 524), the end of the loop can be logged (step 526) after the transformation step 525. The remaining steps of process 500 proceed as described above with respect to process 100 (FIG. 4).

In addition to the benefits of system 10 described above, system 400 (and process 500) including database 477 enables data ingested from data sources 420A-420n to be transformed into a format that may be more accessible or user-friendly for analytics, visualization, etc. Thus, database 477 is an additional component that can be flexibly added once data has been ingested from data sources 420A-420n without requiring alteration of data ingestion pipeline 430. Database 477 can be a different cloud storage option that may be offered through a different service, so moving data from data lake 474 to a different database 477 can also be cost-efficient.

### Dimension and Fact Table Creation for Data Warehouse Using Templates

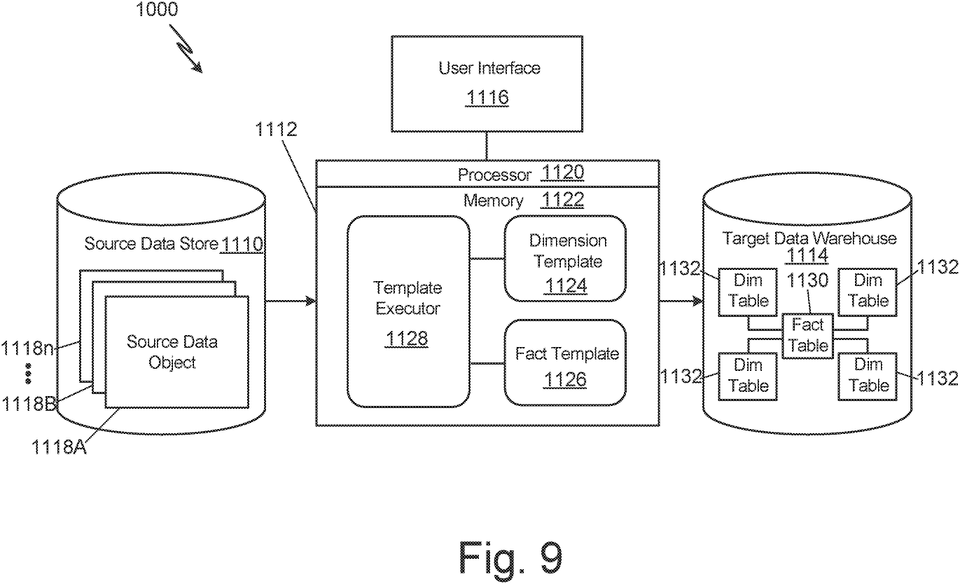

According to techniques of this disclosure, templates for creating dimension and fact tables for a data warehouse include an ordered sequence of steps backed by classes of code that are organized based on common methods, dimension table-specific methods, fact table-specific methods, auditing methods, and transformation processing methods. The templates greatly reduce the time needed to build a data warehouse with dimension and fact tables, and the templates are both reusable and readily modifiable. The data processing system disclosed herein, including the templates for creating dimension and fact tables, and corresponding methods are described below with reference to FIGS. 9-13.

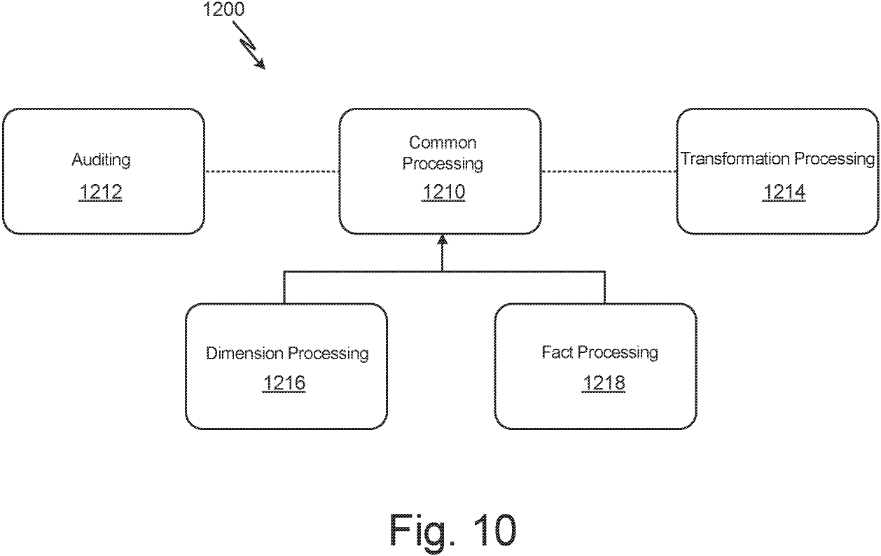

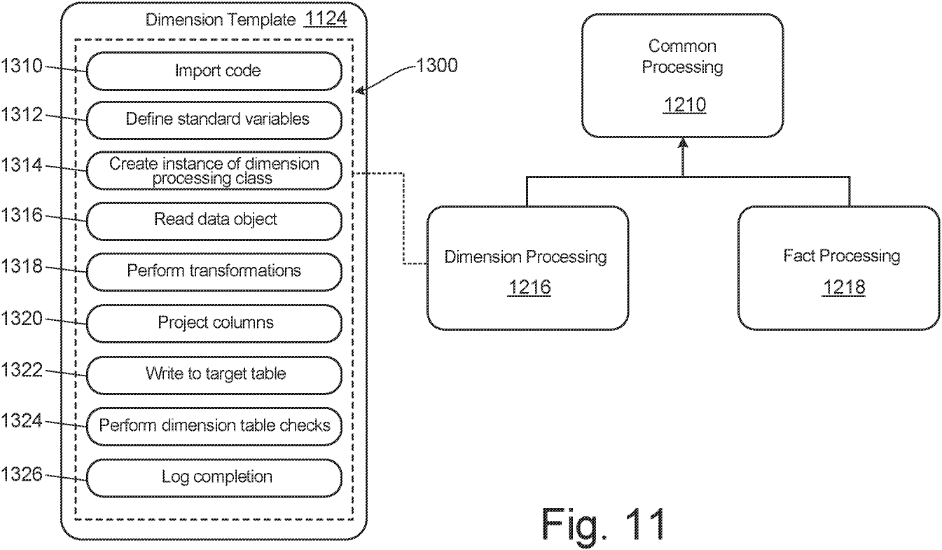

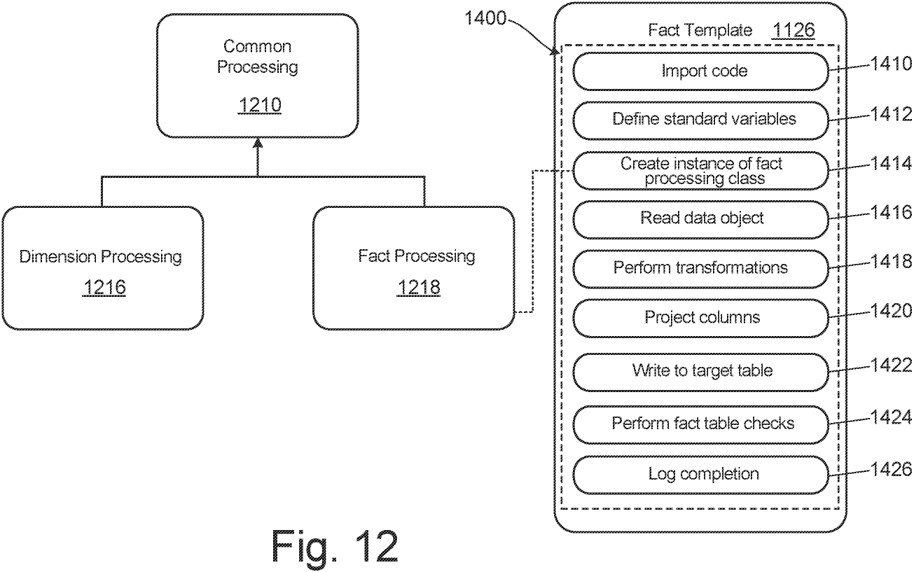

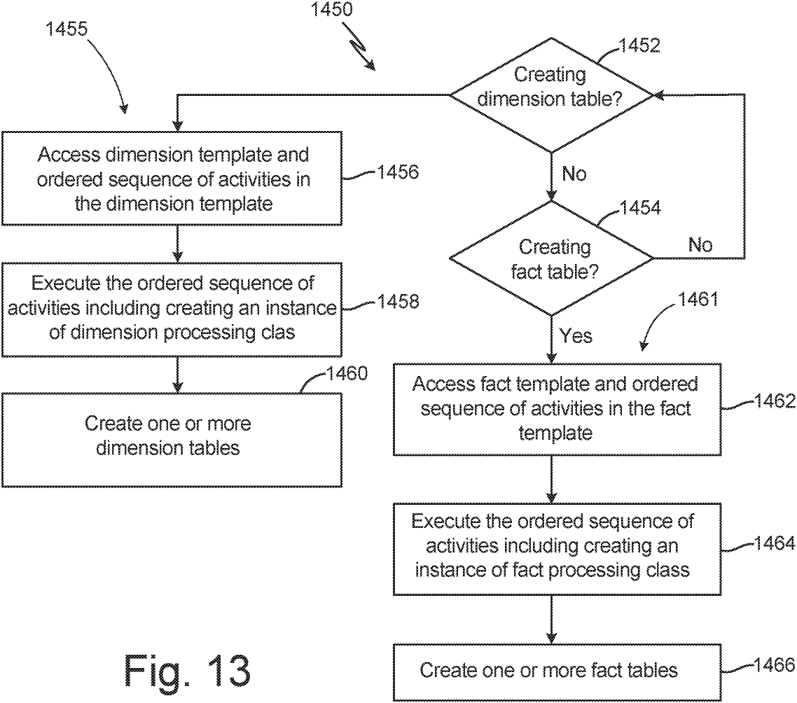

FIGS. 9-13 will be discussed together. FIG. 9 is a schematic block diagram of data processing system 1000 including templates for creating dimension and fact tables. FIG. 10 is a schematic block diagram showing details of class infrastructure 1200. FIG. 11 is a schematic block diagram showing details of dimension template 1124. FIG. 12 is a schematic block diagram showing details of fact template 1126. FIG. 13 is a process flowchart illustrating steps 1452-1466 of process 1450 for creating dimension or fact tables in data processing system 1000.

Data processing system 1000 is a system for processing electronic data. Data processing system 1000 can represent a data pipeline for moving, copying, and/or transforming data from source data store 1110 to target data warehouse 1114. For example, data processing system 1000 can be a system for performing an extract-transform-load (ETL) process or a portion of an ETL process.

As illustrated in FIG. 9, data processing system 1000 includes source data store 1110, computer 1112, target data warehouse 1114, and user interface 1116. Source data store 1110 includes source data objects 1118A-1118n (“n” is used herein as an arbitrary integer to indicate any number of the referenced component). Computer 1112 includes processor 1120, memory 1122, dimension template 1124, fact template 1126, and template executor 1128. Target data warehouse 1114 includes fact table 1130 and dimension tables 1132.

In general, components of data processing system 1000, such as source data store 1110, computer 1112, and target data warehouse 1114, can be remote from each other. For example, source data store 1110 can be an “on-premises” data store (e.g., within an organization’s data centers) or a “cloud” data store (e.g., available using cloud services from vendors such as Amazon, Microsoft, or Google). Similarly, computer 1112 or components of computer 1112 can be wholly or partially cloud-based and can be available through a same or different cloud service as source data store 1110 in examples where source data store 1110 is also cloud-based. Moreover, processing within computer 1112 may not be executed in a fixed location, i.e., one or more processes of computer 1112 can be executed in different locations (e.g., on different processors). Target data warehouse 1114 can also be an on-premises data store or can be cloud-based and available through a same or different cloud service as source data store 1110 and/or computer 1112 in examples where source data store 1110 and/or computer 1112 are also cloud-based.

Source data store 1110 is a collection of electronic data. Source data store 1110 can be a relational, non-relational, or other data storage type. In some examples, source data store 1110 can be a data lake or a zone or container defined within a data lake. In other examples, source data store 1110 can be any suitable store of electronic data. Although a single source data store 1110 is depicted in FIG. 9 for purposes of clarity and ease of discussion, it should be understood that data processing system 1000 can include any number of source data stores 1110. In examples where there is more than one source data store 1110, individual source data stores 1110 can be the same type of data store or can be different types of data stores.

Data located in source data store 1110 can be in any suitable electronic data format. For example, the data can be structured (e.g., rows and columns in a relational database), unstructured, or semi-structured. In some examples, source data store 1110 stores business data, such as employee information, customer information, sales information, financial information, etc., for an organization. In other examples, source data store 1110 can store any type of electronic data. In examples where there is more than one source data store 1110, individual source data stores 1110 can store the same or different types of data.

Source data objects 1118A-1118n each represent a respective portion of the data located in source data store 1110. For example, each of source data objects 1118A-1118n can be a separate file. In some examples, each of source data objects 1118A-1118n can be a Parquet file. Although three source data objects 1118A-1118n are depicted in FIG. 9 for purposes of clarity and ease of discussion, it should be understood that source data store 1110 can include any number of source data objects 1118A-1118n, including more or fewer source data objects 1118A-1118n.

Computer 1112 includes processor 1120 and memory 1122. Although processor 1120 and memory 1122 are illustrated in FIG. 9 as being separate components of a single computer device, it should be understood that in other examples, processor 1120 and memory 1122 can be distributed among multiple connected devices. In yet other examples, memory 1122 can be a component of processor 1120.

Processor 1120 is configured to implement functionality and/or process instructions within data processing system 1000. For example, processor 1120 can be capable of processing instructions stored in memory 1122. Examples of processor 1120 can include one or more of a processor, a microprocessor, a controller, a digital signal processor (DSP), an application specific integrated circuit (ASIC), a field-programmable gate array (FPGA), or other equivalent discrete or integrated logic circuitry.

Memory 1122 can be configured to store information before, during, and/or after operation of data processing system 1000. Memory 1122, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 1122 can be entirely or partly temporary memory, meaning that a primary purpose of memory 1122 is not long-term storage. Memory 1122, in some examples, is described as volatile memory, meaning that memory 1122 does not maintain stored contents when power to devices (e.g., computer 1112) is turned off. Examples of volatile memories can include random access memories (RAM), dynamic random access memories (DRAM), static random access memories (SRAM), and other forms of volatile memories. Memory 1122, in some examples, also includes one or more computer-readable storage media. Memory 1122 can be configured to store larger amounts of information than volatile memory. Memory 1122 can further be configured for long-term storage of information. In some examples, memory 1122 includes non-volatile storage elements. Examples of such non-volatile storage elements can include magnetic hard discs, optical discs, flash memories, or forms of electrically programmable memories (EPROM) or electrically erasable and programmable (EEPROM) memories.

Memory 1122 is encoded with instructions that are executed by processor 1120. For example, memory 1122 can be used to store program instructions for execution by template executor 1128 on processor 1120. In some examples, memory 1122 is used by software or applications running on processor 1120, e.g., template executor 1128, to temporarily store information during program execution.

User interface 1116 can be operatively coupled to computer 1112 to enable user interaction with computer 1112, such as for accessing, configuring, and/or implementing data processing system 1000. User interface 1116 can include a display device and/or other user interface elements (e.g., keyboard, buttons, monitor, graphical control elements presented at a touch-sensitive display, or other user interface elements). In some examples, user interface 1116 includes a graphical user interface (GUI) that includes graphical representations of dimension template 1124 and/or fact template 1126.

Dimension template 1124 and fact template 1126 (referred to collectively herein as “templates 1124, 1126”) are files that can contain executable code, visualizations, and narrative text, including comments, examples, or other documentation. In some examples, templates 1124, 1126 can be in a format that is accessible through a web-based interface (e.g., via user interface 1116), such as a Databricks Notebook. More generally, templates 1124, 1126 can be any suitable format for representing a configuration of code to be executed by processor 1120. Templates 1124, 1126 can support various programming languages, such as Python, Structured Query Language (SQL), etc. Additionally, templates 1124, 1126 can include interfaces for connecting to various application programming interfaces (APIs). For example, templates 1124, 1126 can include a PySpark interface for connecting to the Apache Spark data analytics engine.

As will be described in greater detail below with respect to FIG. 10, templates 1124, 1126 are backed by class infrastructure 1200, which is an organization of the code (i.e., methods) for building dimension and fact tables. Templates 1124, 1126 leverage the code contained in class infrastructure 1200 to create dimension and fact tables. More specifically, templates 1124, 1126 each include several steps-represented as modules in FIGS. 11 and 12—and each step can encompass multiple methods (e.g., as would be represented in one or more lines of code) from class infrastructure 1200. In some examples, the code or parts of the code in class infrastructure 1200 can be hidden from a user at the template level (e.g., not visible when a user accesses templates 1124, 1126). Moreover, the functionality that corresponds to each step or module in templates 1124, 1126 (based on the methods in class infrastructure 1200) can be modified in such a way that the change is not visible to a user because additional methods can be added into the underlying class. For example, a method to modify the functionality of creating a dimension table can be added into dimension processing class 1216, a method to modify the functionality of creating a fact table can be added into fact processing class 1218, a method to modify the functionality of creating both a dimension table and a fact table can be added into common processing class 1210, and a method to modify auditing or transformation processing can be added into auditing component 1212 or transformation processing component 1214 of common processing class 1210.

Templates 1124, 1126 contain an ordered sequence of steps or activities for creating dimension and fact tables, respectively. As will be described in greater detail below with respect to FIGS. 11 and 12, dimension template 1124 contains a first ordered sequence of steps for creating dimension tables (FIG. 11) and fact template 1126 contains a second ordered sequence of steps for creating fact tables (FIG. 12). The ordered sequence of steps for templates 1124, 1126 can be standardized steps. Some steps in templates 1124, 1126 can be preset steps or steps that are not modifiable by a user and require no user input. Other steps can require user input, e.g., in the form of a code statement entered by a user. Steps that require user input are application-specific steps that may differ each time data processing system 1000 runs (i.e., each time the steps of dimension template 1124 or fact template 1126 are executed). For example, a user might specify which source data object 1118A-1118n will be read. Templates 1124, 1126 can include indications of sections of the template where the user can input a code statement. The user input can be a code statement in any suitable programming language for dimension template 1124 and/or fact template 1126, such as Python, SQL, etc. Templates 1124, 1126 can also include examples of code statements that a user can fill in. More generally, templates 1124, 1126 can each include any suitable number of steps for guiding the process of creating dimension tables 1132 and/or fact table 1130. Moreover, the number of steps in templates 1124, 1126 can be modified such that templates 1124, 1126 include more or fewer steps or different steps. In some examples, templates 1124, 1126 can have a same or similar number of steps. In other examples, templates 1124, 1126 have a different number of steps.

Template executor 1128 executes the code that is organized in templates 1124, 1126. Template executor 1128 can be compatible with various programming languages, such as Python, SQL, etc. In some examples, template executor 1128 is part of a web-based interface for accessing and running templates 1124, 1126, such as part of a Databricks Notebook. In such examples, template executor 1128 may be initiated from a “run” or similar command that is available to a user. Template executor 1128 can execute all the steps of dimension template 1124 and/or fact template 1126 or can execute individual steps. Further, template executor 1128 can be configured to execute the steps of templates 1124, 1126 based on a trigger, which can include scheduling template executor 1128 to run (i.e., execute the steps of dimension template 1124 and/or fact template 1126) automatically after a defined period elapses or after a trigger event occurs. Trigger events can include, for example, updates to a dataset, such as an update to the data stored in source data store 1110.

Target data warehouse 1114 is a destination data store for data processed according to the steps of dimension template 1124 and/or fact template 1126. Target data warehouse 1114 can be located remotely from source data store 1110. Target data warehouse 1114 can be, for example, a data warehouse zone defined within a data lake. In other examples, target data warehouse 1114 can be any suitable data store type. Target data warehouse 1114 stores fact table 1130 and dimension tables 1132, which can include transformed data to be used for tasks such as reporting, visualization, analytics, machine learning, etc. One or more users, such as data engineers, data scientists, or any other users, can connect to target data warehouse 1114 to access and use data that is stored within target data warehouse 1114.

Fact table 1130 is created via execution of the steps of fact template 1126 by template executor 1128. Fact table 1130 is a data structure that includes data organized into rows and columns. Fact table 1130 contains measurements or metrics (i.e., facts) for an event, such as a business process. For example, fact table 1130 can contain information about a business’s sales. In other examples, fact table 1130 can contain any measurements or metrics. Fact table 1130 can be a different type of fact table, such as transactional fact table, a periodic snapshot table, etc., depending on the methods called from fact template 1126. Dimension tables 1132 are created via execution of the steps of dimension template 1124 by template executor 1128. Like fact table 1130, dimension tables 1132 are data structures that include data organized into rows and columns. Dimension tables 1132 contain descriptive information or attributes (i.e., dimensions) about the facts in fact table 1130. For example, if fact table 1130 contains sales information, ones of dimension tables 1132 can contain a product type that was sold (product type), which employee who made the sale (employee), and which customer bought the product (customer). In other examples, dimension tables 1132 can contain any descriptive information or attributes associated with the facts in fact table 1130.

As illustrated in FIG. 9, there can be one or more dimension tables 1132 for each fact table 1130. Although a single fact table 1130 is depicted in FIG. 9 for purposes of clarity and ease of discussion, it should be understood that target data warehouse 1114 can include any number of fact tables 1130 associated with any number of corresponding dimension tables 1132. For example, target data warehouse 1114 can include multiple fact tables 1130, each having one or more corresponding dimension tables 1132. The number of fact tables 1130 and corresponding dimension tables 1132 can depend on the type of data organized in target data warehouse 1114. In the example shown in FIG. 9, the records in fact table 1130 are defined by four different dimensions (four dimension tables 1132). In another example, the records in fact table 1130 can be defined by more or fewer different dimensions (more or fewer dimension tables 1132). The overall relationship between fact table 1130 and dimension tables 1132 in target data warehouse 1114 can be represented in a schema of target data warehouse 1114, such as a star schema, a snowflake schema, or another type of schema.

Referring now to FIG. 10, class infrastructure 1200 includes common processing class 1210, including auditing component 1212 and transformation processing component 1214, dimension processing class 1216, and fact processing class 1218. Class infrastructure 1200 is an organization of code in an object-oriented programming paradigm. Each class represented in class infrastructure 1200 is a grouping of code (i.e., methods) that is available to objects instantiated from the respective class. Class infrastructure 1200 organizes the code that makes up the steps of dimension template 1124 and fact template 1126. In some examples, the code in class infrastructure 1200 is written in the Python programming language. In other examples, the code in class infrastructure 1200 can be written in any suitable programming language for object-oriented programming.

Common processing class 1210 is a class within class infrastructure 1200. Common processing class 1210 is a parent or base class that contains all the code (i.e., methods) that is shared between the processes for creating dimension and fact tables. That is, if a method is used in both dimension template 1124 and fact template 1126, it can be included in common processing class 1210. Common processing class 1210 can include methods for defining a full load (loading an entire data object, e.g., one of source data objects 1118A-1118n) or an incremental load (identifying and loading only any changes or new portions of the data object since the last time the data object was accessed). In some examples, incremental load methods can include hashing functions. It may be desirable to perform an incremental load of dimension template 1124 or fact template 1126 if there are many records to be read from source data store 1110, such as hundreds of thousands, millions, or other amounts.

Common processing class 1210 also includes methods for generating and storing information about data origin, lineage, and context (i.e., metadata) within data processing system 1000. These methods can be conceptually represented in auditing component 1212 and transformation processing component 1214 of common processing class 1210. Auditing component 1212 and transformation processing component 1214 can be subsets of common processing class 1210. In some examples, auditing component 1212 and transformation processing component 1214 can be implemented separately from the other methods of class infrastructure 1200. Auditing component 1212 can include methods to capture information that includes, but is not limited to, an identification of data objects that are read or written in data processing system 1000, a number of records (e.g., rows of a table) that are read or written from a respective data object, and a duration of an operation (e.g., a duration of executing one or more or all of the steps of dimension template 1124 or fact template 1126, such as steps for reading or writing data) within data processing system 1000. Auditing component 1212 can be implemented by an instance of dimension processing class 1216 or fact processing class 1218, or can be independently implemented if a user wants to perform auditing functionality separate from creating dimension or fact tables. Similarly, transformation processing component 1214 can include methods to capture information that includes, but is not limited to, a description of a transformation processing step (i.e., a data transformation step) within dimension template 1124 or fact template 1126, a duration of the transformation processing step, and a number of records read or written in the transformation processing step. Transformation processing component 1214 can also include methods for recording actual code statements, such as SQL statements, that are entered by a user into modules of templates 1124, 1126.

Dimension processing class 1216 includes methods that are specific to creating dimension tables 1132. Accordingly, dimension processing class 1216 is instantiated when template executor 1128 executes the steps of dimension template 1124. Dimension processing class 1216 can be considered a child class of common processing class 1210 such that an instance of dimension processing class 1216 inherits from common processing class 1210. That is, dimension processing class 1216 can inherit all the functionality of common processing class 1210 and include any additional functionality (methods) defined in dimension processing class 1216.

Fact processing class 1218 includes methods that are specific to creating fact table 1130. Accordingly, fact processing class 1218 is instantiated when template executor 1128 executes the steps of fact template 1126. Like dimension processing class 1216, fact processing class 1218 can be considered a child class of common processing class 1210 such that an instance of fact processing class 1218 inherits from common processing class 1210. That is, fact processing class 1218 can inherit all the functionality of common processing class 1210 and include any additional functionality (methods) defined in fact processing class 1218.

Referring now to FIG. 11, dimension template 1124 includes ordered sequence of activities 1300 arranged in modules 1310-1326 for creating dimension tables 1132 in target data warehouse 1114.

First module 1310 represents a first step or set of steps within ordered sequence of activities 1300 of dimension template 1124. First module 1310 includes standard steps for initializing dimension template 1124. For example, first module 1310 includes a step for importing all the code from class infrastructure 1200 so that it is usable by dimension template 1124. First module 1310 can also include other standard steps, such as setting up any widgets in dimension template 1124 (e.g., template view type, etc.), creating an instance of a logger, or any other standard steps for initializing dimension template 1124.

Second module 1312 represents a second step or set of steps within ordered sequence of activities 1300 of dimension template 1124. Second module 1312 includes a step for defining variables to be used with methods called by dimension template 1124. Second module 1312 can require user input to define some variables, e.g., to specify an identification of one or more of source data objects 1118A-1118n (from corresponding source data store 1110) from which one or more dimension tables 1132 will be created. The variables that require user input are variables that depend on the particular application of dimension template 1124. Some variables can be standard (or not require user input), e.g., an identification of target data warehouse 1114 where dimension tables 1132 will be created, an identification of dimension template 1124, a subject area associated with dimension template 1124, or any other standard variables that are repeated for each iteration of dimension template 1124.

Third module 1314 represents a third step or set of steps within ordered sequence of activities 1300 of dimension template 1124. Third module 1314 includes a step for creating an instance of dimension processing class 1216 (from class infrastructure 1200, as illustrated by the dashed line in FIG. 11).

Fourth module 1316 represents a fourth step or set of steps within ordered sequence of activities 1300 of dimension template 1124. Fourth module 1316 includes a step for reading one or more data objects 1118A-1118n form source data store 1110. Reading the one or more data objects 1118A-1118n can further include copying the one or more data objects 1118A-1118n. Fourth module 1316 can require user input to indicate which of source data objects 1118A-1118n will be read. Fourth module 1316 can also invoke a method (e.g., from auditing component 1212 of class infrastructure 1200) for logging and storing metadata associated with the one or more data objects 1118A-1118n that will be read. In this way, data origin and lineage information is preserved because a user indicates which data objects 1118A-1118n to read, and dimension template 1124 is predefined to create a dimension table in target data warehouse 1114.

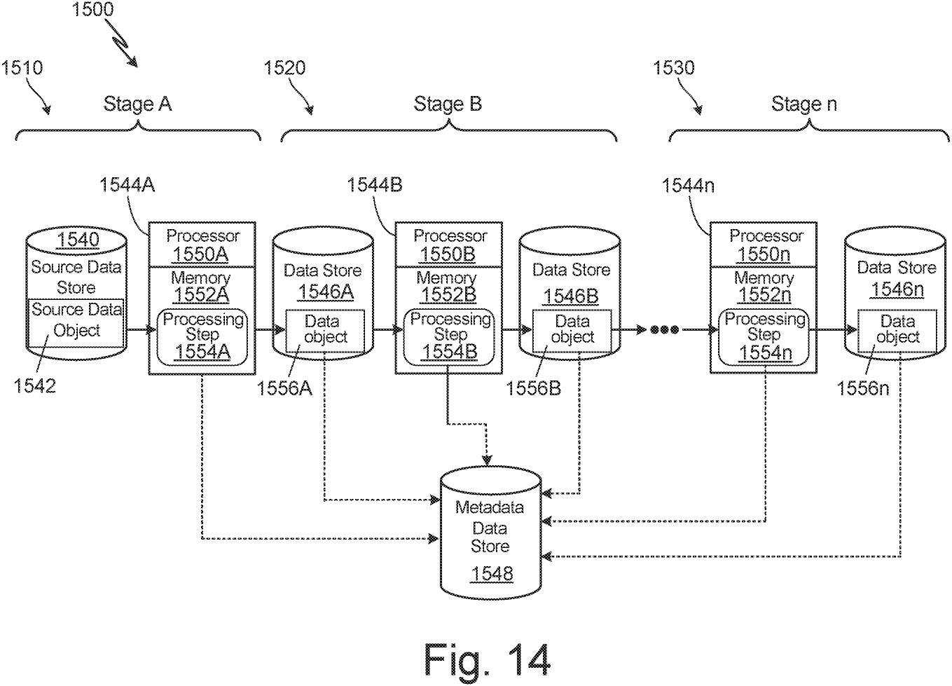

Fifth module 1318 represents a fifth step or set of steps within ordered sequence of activities 1300 of dimension template 1124. Fifth module 1318 includes a step for performing transformations on data objects 1118A-1118n that are read from source data store 1110 in the previous step (e.g., at fourth module 1316). Fifth module 1318 can require user input to indicate desired transformations. For example, the transformations to be performed can be application-specific and dependent on a business logic associated with data processing system 1000. Any transformation methods called in fifth module 1318 are available from the instance of dimension processing class 1216. In some examples, fifth module 1318 can include instructions that are visible to a user to identify scenarios when a user might want to choose certain transformations (methods). In some examples, certain transformations can be associated with a type of dimension table to be created. Fifth module 1318 can also invoke a method (e.g., from transformation processing component 1214 of class infrastructure 1200) for logging and storing metadata associated with the transformations that are performed. As will be described in greater detail below with respect to FIGS. 14-16, the method for storing metadata can include storing the actual code statement that is input by a user.

Sixth module 1320 represents a sixth step or set of steps within ordered sequence of activities 1300 of dimension template 1124. Sixth module 1320 includes a step for projecting, or identifying, attributes from data objects 1118A-1118n (ones of data objects 1118A-1118n that were read from source data store 1110 at fourth module 1316 and, optionally, transformed at fifth module 1318) that will correspond to columns in the target or final dimension table(s) 1132. Sixth module 1320 can require user input to specify the columns for dimension tables 1132 based on the attributes of the respective data objects 1118A-1118n.

Seventh module 1322 represents a seventh step or set of steps within ordered sequence of activities 1300 of dimension template 1124. Seventh module 1322 includes a step for writing data to the target dimension table(s) 1132. The data that is written to the target dimension table 1132 comes from one or more data objects 1118A-1118n that were copied from source data store 1110 (fourth module 1316) and, optionally, transformed (fifth module 1318). Seventh module 1322 can also invoke a method (e.g., from auditing component 1212 of class infrastructure 1200) for logging and storing metadata associated with the one or more data objects 1118A-1118n that will be written to the target dimension table 1132.

Eighth module 1324 represents an eighth step or set of steps within ordered sequence of activities 1300 of dimension template 1124. Eighth module 1324 includes a step for performing checks to validate the target dimension table(s) 1132. In some examples, the checks are standard checks using predefined methods (e.g., from dimension processing class 1216). In some examples, the checks can be automatically included in eighth module 1324 based on other steps that were performed in ordered sequence of activities 1300 of dimension template 1124. In other examples, eighth module 1324 can include instructions for a user, such as a developer, to perform a review of the code prior to deploying the code to create the target dimension tables 1132. Failed checks can indicate that the target dimension table 1132 in progress is not yet ready to be deployed to a higher environment (e.g., a production environment). In some examples, dimension template 1124 can include alerts for failed checks.

Ninth module 1326 represents a tenth (or sequentially last) step or set of steps within ordered sequence of activities 1300 of dimension template 1124. Accordingly, ninth module 1326 represents an end of ordered sequence of activities 1300, such that an execution of dimension template 1124 terminates after ninth module 1326 runs. Ninth module 1326 includes a step for logging completion of dimension template 1124.

Dimension template 1124 can also include any additional steps for creating dimension tables 1132. Additional steps can be represented in additional modules, which can be added in any order with respect to modules 1310-1326. For example, in a healthcare context, dimension template 1124 can include or can be modified to include modules with steps for generating an indication or alert that protected health information (PHI) or personal identifiable information (PII) is present in the data object (e.g., based on metadata associated with the data object) and creating a limited view to protect the PHI/PII from unauthorized viewing. In other examples, an additional module can include housekeeping steps or standard data warehousing best practices, such as steps to create a surrogate key to uniquely identify each entity in the dimension table or steps to add an “unknown record” for situations where a fact is properly recorded in the fact table but there is no corresponding record in the dimension table associated with that fact. These steps can be specific to dimension template 1124. Moreover, any one or more of modules 1310-1326 can be combined with each other to include the combination of steps that are represented in the separate modules and preserve ordered sequence of activities 1300. Further, some steps or entire modules within dimension template 1124 can be optional for a particular application. For example, a user may choose not to perform any data transformations on the data object 1118A-1118n, so fifth module 1318 would not be used. In that case, a user can deactivate (e.g., “comment out”) the undesired steps or module so that it is not performed when template executor 1128 executes the steps of dimension template 1124.

Referring now to FIG. 12, fact template 1126 includes ordered sequence of activities 1400 arranged in modules 1410-1426 for creating fact table 1130 in target data warehouse 1114.

First module 1410 represents a first step or set of steps within ordered sequence of activities 1400 of fact template 1126. First module 1410 includes standard steps for initializing fact template 1126. For example, first module 1410 includes a step for importing all the code from class infrastructure 1200 so that it is usable by fact template 1126. First module 1410 can also include other standard steps, such as setting up any widgets in fact template 1126 (e.g., template view type, etc.), creating an instance of a logger, or any other standard steps for initializing fact template 1126.

Second module 1412 represents a second step or set of steps within ordered sequence of activities 1400 of fact template 1126. Second module 1412 includes a step for defining variables to be used with methods called by fact template 1126. Second module 1412 can require user inputs to define some variables, e.g., to specify an identification of one or more of source data objects 1118A-1118n (from corresponding source data store 1110) from which one or more fact tables 1130 will be created. The variables that require user inputs are variables that depend on the particular application of fact template 1126. Some variables can be standard (or not require user inputs), e.g., an identification of target data warehouse 1114 where fact table 1130 will be created, an identification of fact template 1126, a subject area associated with fact template 1126, or any other standard variables that are repeated for each iteration of fact template 1126.

Third module 1414 represents a third step or set of steps within ordered sequence of activities 1400 of fact template 1126. Third module 1414 includes a step for creating an instance of fact processing class 1218 (from class infrastructure 1200, as illustrated by the dashed line in FIG. 12).

Fourth module 1416 represents a fourth step or set of steps within ordered sequence of activities 1400 of fact template 1126. Fourth module 1416 includes a step for reading one or more data objects 1118A-1118n form source data store 1110. Reading the one or more data objects 1118A-1118n can further include copying the one or more data objects 1118A-1118n. Fourth module 1416 can require user input to indicate which of source data objects 1118A-1118n will be read. Fourth module 1416 can also invoke a method (e.g., from auditing component 1212 of class infrastructure 1200) for logging and storing metadata associated with the one or more data objects 1118A-1118n that will be read. In this way, data origin and lineage information is preserved because a user indicates which data objects 1118A-1118n to read, and fact template 1126 is predefined to create a fact table in target data warehouse 1114.

Fifth module 1418 represents a fifth step or set of steps within ordered sequence of activities 1400 of fact template 1126. Fifth module 1418 includes a step for performing transformations on data objects 1118A-1118n that are read from source data store 1110 in the previous step (e.g., at fourth module 1416). Fifth module 1418 can require user input to indicate desired transformations. For example, the transformations to be performed can be application-specific and dependent on a business logic associated with data processing system 1000. For example, one typical transformation for fact tables is a transformation to replace null values from the data object. In a healthcare example where a patient has not yet seen a provider, target data warehouse 1114 could have other information for the patient, but a provider visit date column would reflect a null value, so the data could be transformed to replace the visit date null values with, e.g., “-1.” Any transformation methods called in fifth module 1418 are available from the instance of fact processing class 1218. In some examples, fifth module 1418 can include instructions that are visible to a user to identify scenarios when a user might want to choose certain transformations (methods). In some examples, certain transformations can be associated with a type of fact table to be created. Fifth module 1418 can also invoke a method (e.g., from transformation processing component 1214 of class infrastructure 1200) for logging and storing metadata associated with the transformations that are performed. As will be described in greater detail below with respect to FIGS. 14-16, the method for storing metadata can include storing the actual code statement that is input by a user. Based on the chosen data transformations, fifth module 1418 can include a method for establishing a final schema for target data warehouse 1114.

Sixth module 1420 represents a sixth step or set of steps within ordered sequence of activities 1400 of fact template 1126. Sixth module 1420 includes a step for projecting, or identifying, attributes from data objects 1118A-1118n (ones of data objects 1118A-1118n that were read from source data store 1110 at fourth module 1416 and, optionally, transformed at fifth module 1418) that will correspond to columns in the target or final fact table(s) 1130. Sixth module 1420 can require user input to specify the columns for fact table 1130 based on the attributes of the respective data objects 1118A-1118n.

Seventh module 1422 represents a seventh step or set of steps within ordered sequence of activities 1400 of fact template 1126. Seventh module 1422 includes a step for writing data to the target fact table(s) 1130. The data that is written to the target fact table 1130 comes from one or more data objects 1118A-1118n that were copied from source data store 1110 (fourth module 1416) and, optionally, transformed (fifth module 1418). Seventh module 1422 can also invoke a method (e.g., from auditing component 1212 of class infrastructure 1200) for logging and storing metadata associated with the one or more data objects 1118A-1118n that will be written to the target fact table 1130.

Eighth module 1424 represents a eighth step or set of steps within ordered sequence of activities 1400 of fact template 1126. Eighth module 1424 includes a step for performing checks to validate the target fact table(s) 1130. In some examples, the checks are standard checks using predefined methods (e.g., from fact processing class 1218). In some examples, the checks can be automatically included in eighth module 1424 based on other steps that were performed in ordered sequence of activities 1400 of fact template 1126. For example, if data objects 1118A-1118n include null values, there can be an automatic check in eighth module 1424 to determine if a transformation was performed at fifth module 1416 to replace the null values. In other examples, eighth module 1424 can include instructions for a user, such as a developer, to perform a review of the code prior to deploying the code to create the target fact tables 1130. Failed checks can indicate that the target fact table 1130 in progress is not yet ready to be deployed to a higher environment (e.g., a production environment). In some examples, fact template 1126 can include alerts for failed checks.

Ninth module 1426 represents a ninth (or sequentially last) step or set of steps within ordered sequence of activities 1400 of fact template 1126. Accordingly, ninth module 1426 represents an end of ordered sequence of activities 1400, such that an execution of fact template 1126 terminates after ninth module 1426 runs. Ninth module 1426 includes a step for logging completion of fact template 1126.

Fact template 1126 can also include any additional steps for creating fact tables 1130. Additional steps can be represented in additional modules, which can be added in any order with respect to modules 1410-1426. For example, in a healthcare context, fact template 1126 can include or can be modified to include modules with steps for generating an indication or alert that protected health information (PHI) or personal identifiable information (PII) is present in the data object and creating a limited view to protect the PHI/PII from unauthorized viewing. In other examples, because creating fact tables 1130 may be one of the final steps of building target data warehouse 1114, a developer may want to perform additional validation tests after projecting the columns (sixth module 1420), so an additional module can include a step for creating an extra process view frame to allow the developer to perform these tests before deploying the code. Moreover, any one or more of modules 1410-1426 can be combined with each other to include the combination of steps that are represented in the separate modules and preserve ordered sequence of activities 1400. Further, some steps or entire modules within fact template 1126 can be optional for a particular application. For example, a user may choose not to perform any data transformations on the data object 1118A-1118n, so fifth module 1418 would not be used. In that case, a user can deactivate (e.g., “comment out”) the undesired steps or module so that it is not performed when template executor 1128 executes the steps of fact template 1126.

The operation of data processing system 1000 will be described with reference to FIGS. 9-13. In operation, a user, such as a developer, a data engineer, etc., can access dimension template 1124, and corresponding ordered sequence of activities 1300, and/or fact template 1126, and corresponding ordered sequence of activities 1400, from computer 112 via user interface 1116. As illustrated in FIG. 13, a first set of decisions in process 1450 can be a decision to create a dimension table (decision block 1452) or a decision to create a fact table (decision block 1454). If a dimension table will be created (YES at block 1452), then process 1450 proceeds down first sequence of steps 1455. If a dimension table will not be created (NO at block 1452) but a fact table will be created (YES at block 1454), then process 1450 proceeds down second sequence of steps 1461. At step 1456 of first sequence of steps 1455, dimension template 1124 and corresponding ordered sequence of activities 1300 are accessed. Alternatively, at step 1462 of second sequence of steps 1461, fact template 1126 and corresponding ordered sequence of activities 1400 are accessed.

After accessing dimension template 1124 or fact template 1126, a user can view the template steps, view any comments or examples included with the steps, input user code, and run the respective template steps to create a dimension or fact table. The user can input a code statement into steps or modules of dimension template 1124 and/or fact template 1126 that require user input (e.g., modules 1312, 1316, 1318, and 1320 for dimension template 1124 and modules 1412, 1416, 1418 and 1420 for fact template 1126) to specify application-specific parts of the process. In some examples, a user can remove or deactivate one or more modules in dimension template 1124 and/or fact template 1126 if desired for the user’s particular application.

The user can direct template executor 1128 to execute ordered sequence of activities 1300 of dimension template 1124 (step 1458 in FIG. 13) or ordered sequence of activities 1400 of fact template 1126 (step 1464 in FIG. 13), e.g., by entering a command or performing a corresponding action, or template executor 1128 can execute the steps of dimension template 1124 or fact template 1126 automatically based on a triggering event. Template executor 1128 executes the selected one of dimension template 1124 and fact template 1126. One or more dimension tables 1132 are created from an execution (or run) of dimension template 1124 (step 1460 in FIG. 13), wherein data is read from one or more data objects 1118A-1118n, processed and transformed according to the methods in dimension template 1124, and written to target data warehouse 1114. In other words, one or more dimension tables 1132 can be created when template executor 1128 creates an instance of dimension processing class 1216 because dimension processing class 1216 contains the methods called in dimension template 1124 that are dimension table-specific. One or more fact tables 1130 are created from an execution (or run) of fact template 1126 (step 1466 in FIG. 13), wherein data is read from one or more data objects 1118A-1118n, processed and transformed according to the methods in fact template 1126, and written to target data warehouse 1114. In other words, one or more fact tables 1130 can be created when template executor 1128 creates an instance of fact processing class 1218 because fact processing class 1218 contains the methods called in fact template 1126 that are fact table-specific.

In the overall development lifecycle for a data warehouse, a significant portion of the time is spent building dimension and fact tables. Typically, dimension and fact tables are built from scratch for each project, and there may be very little guidance available to developers, who will each have their own way of writing code. The traditional process of building dimension and fact tables for a data warehouse is therefore relatively unstructured. According to techniques of this disclosure, templates 1124, 1126 leveraging class infrastructure 1200 can accelerate creation of dimension and fact tables by providing more guidance to developers. Building a hand-crafted data warehouse for each application can take many weeks or months. In contrast, data processing system 1000, including templates 1124, 1126 that leverage class infrastructure 1200 can build the main components of a data warehouse (dimension tables 1132 and fact table 1130) in a much shorter time, such as days or weeks.

Templates 1124, 1126 not only reduce the amount of time required to build dimension and fact tables but also include other supporting code (e.g., data warehousing best practices, integrated metadata generation and storage, etc.) to bring the data warehouse deliverable up to a higher standard. Templates 1124, 1126 minimize the work a developer must do to produce high quality data warehouse 1114 by guiding the developer through the steps for building dimension and fact tables. This guidance can be especially important if business clients eventually want to take over managing data processing system 1000.

At the same time, class infrastructure 1200 can include a library of methods for building various types of dimension and fact tables with different requirements, so templates 1124, 1126 can be highly flexible. For a hand-crafted build process, a developer might only have time to include the minimum necessary code for the particular build. However, class infrastructure 1200 is a way of making any methods that could be used for building dimension and fact tables available to a user. Class infrastructure 1200 with common processing class 1210 separate from dimension processing class 1216 and fact processing class 1218 enables methods corresponding to each process (i.e., building dimension and fact tables, respectively) to be logically organized. Common processing class 1210 provides a means for efficiently managing parts of each process that overlap or are shared. Additionally, the template format of templates 1124, 1126 that leverage class infrastructure 1200 enables a developer to easily modify or evolve the process of building dimension and fact tables by adding or removing methods from a corresponding class in class infrastructure 1200 without making significant changes to templates 1124, 1126. That is, to some extent, changes to methods in class infrastructure 1200 that affect the functionality of templates 1124, 1126 can be hidden from users at the template level. In this way, using templates 1124, 1126 can be a simpler process for building dimension and fact tables than hand-crafted processes that can require directly interacting with large blocks of relatively unorganized code.

### Integrated Metadata Generation and Storage in Metadata-Based Data Processing System

According to techniques of this disclosure, a metadata-based data processing system includes integrated metadata-gathering to build a metadata data store that stores process definition metadata correlated with runtime metadata. The metadata data store is more robust and enables more insight into the processes carried out in the data processing system than traditional data cataloging options because the metadata data store automatically stores actual runtime metadata from the process, in addition to other metadata, such as record counts, date, time, etc. The data processing system disclosed herein, including integrated metadata-gathering, and corresponding methods are described below with reference to FIGS. 14-16.

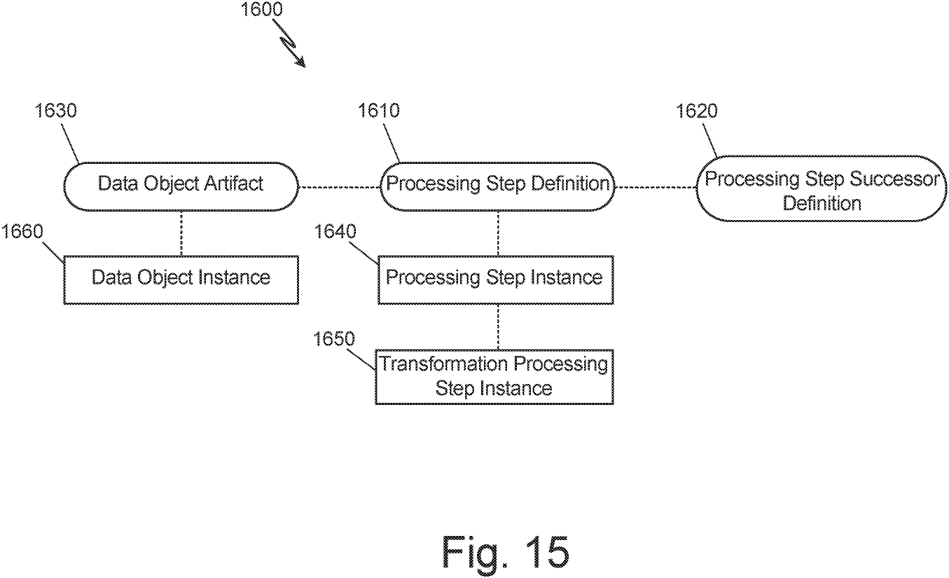

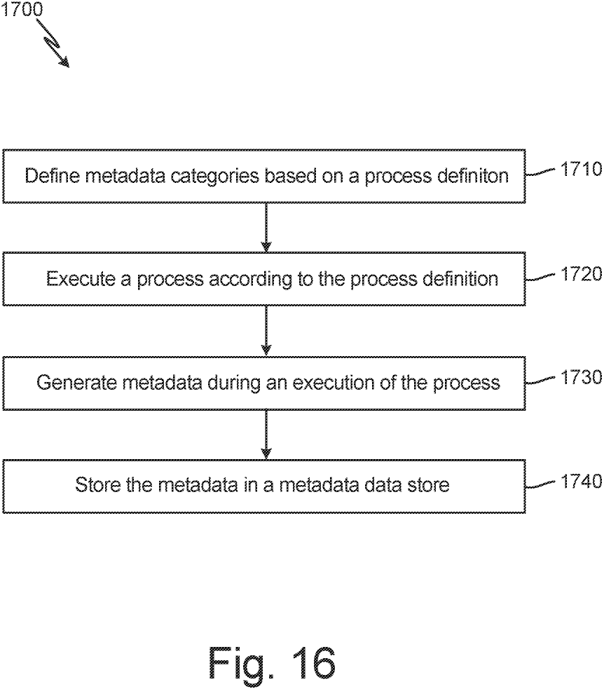

FIGS. 14-16 will be discussed together. FIG. 14 is a schematic block diagram of data processing system 1500 for generating and storing metadata. FIG. 15 is a schematic block diagram of schema 1600 for organizing metadata in data processing system 1500. FIG. 16 is a process flowchart illustrating steps 1710-1740 of process 1700 for generating and storing metadata in data processing system 1500.

As illustrated in FIG. 14, data processing system 1500 includes first stage 1510, intermediate stage 1520, final stage 1530, source data store 1540, source data object 1542, computers 1544A-1544n, sequential data stores 1546A-1546n, and metadata data store 1548. Each of computers 1544A-1544n includes a corresponding processor 1550A-1550n, memory 1552A-1552n, and processing step 1554A-1554n. Each of sequential data stores 1546A-1546n includes a corresponding data object 1556A-1556n. As illustrated in FIG. 15, schema 1600 includes processing step definition block 1610, processing step successor definition block 1620, data object artifact block 1630, processing step instance block 1640, transformation processing step instance block 1650, and data object instance 660.

Data processing system 1500 is a system for processing electronic data. Data processing system 1500 can represent a data pipeline or pipelines for moving, copying, and/or transforming data from source data store 1540 through sequential data stores 1546A-1546n. For example, data processing system 1500 can be a system for performing an extract-transform-load (ETL) process. In some examples, data processing system 1500 can be an enterprise-level system for integrating data for business intelligence (BI) initiatives.

Data processing system 1500 has a corresponding process definition, or order of data pipelines or processing steps, that is encapsulated in metadata (i.e., process definition metadata). Accordingly, data processing system 1500 is a metadata-based system. The process definition of data processing system 1500 encompasses a sequence of processing steps 1554A-1554n and respective data stores (source data store 1540 and sequential data stores 1546A-1546n) from which data objects 1542, 1554A-1554n are produced or consumed. In other words, the process definition is effectively a configuration of data processing system 1500. The process definition of data processing system 1500 can be defined or stored such that it is accessible in the compute environment for data processing system 1500 (e.g., stored in memory 1552A-1552n and accessible by processors 1550A-1550n).

Data processing system 1500 (and its corresponding process definition) can be divided into one or more stages. As illustrated in FIG. 14, data processing system 1500 includes first stage 1510 (Stage A), intermediate stage 1520 (Stage B), and final stage 1530 (Stage n). Although FIG. 14 depicts a single intermediate stage 1520 for purposes of clarity and ease of discussion, other examples of data processing system 1500 can include any number of intermediate stages 1520 (which could be represented, e.g., as intermediate stages 1520A-1520n in sequential order). Moreover, the example shown in FIG. 14 includes three sequential stages (first stage 1510, intermediate stage 1520, and final stage 1530), but it should be understood that other examples can include more or fewer stages. One such example of a data processing system could consist of only first stage 1510. Another example could consist of first stage 1510 and final stage 1530. Yet other examples could consist of first stage 1510, multiple intermediate stages 1520, and final stage 1530.

First stage 1510 represents a portion of data processing system 1500 (i.e., a first data pipeline) for copying, moving, and/or transforming data from source data store 1540 to sequential data store 1546A. Intermediate stage 1520 represents a portion of data processing system 1500 (i.e., a second data pipeline) for copying, moving, and/or transforming data from sequential data store 1546A to sequential data store 1546B. Final stage 1530 represents a portion of data processing system 1500 (i.e., a third data pipeline) for copying, moving, and/or transforming data to sequential data store 1546n from a sequentially previous data store 1546 (e.g., sequential data store 1546B in the example shown in FIG. 14). In some examples, first stage 1510 can be an embodiment of data pipeline system 10, 200, 400 as described above with reference to FIGS. 1-8. Each intermediate stage 1520 (i.e., portions of data processing system 1500 from one sequential data store 1546A-1546n to the sequentially next or subsequent data store 1546A-1546n, e.g., from data store 1546A to data store 1546B) can represent various other processes or processing steps that may be implemented in an ETL process, including data cleansing steps, quality control steps, data transformations, etc. In some examples, final stage 1530 can be an embodiment of data processing system 1000 as described above with respect to FIGS. 9-13, such that sequentially last data store 1546n can be an embodiment of target data warehouse 1114 (FIG. 9).

In general, components of data processing system 1500, such as source data store 1540, computers 1544A-1544n, sequential data stores 1546A-1546n, and metadata data store 1548 can be remote from each other. For example, source data store 1540 can be an “on-premises” data store (e.g., within an organization’s data centers) or a “cloud” data store (e.g., available using cloud services from vendors such as Amazon, Microsoft, or Google). Similarly, each of computers 1544A-1544n or components of computers 1544A-1544n can be wholly or partially cloud-based and can be available through a same or different cloud service as source data store 1540 in examples where source data store 1540 is also cloud-based. Moreover, processing steps 1554A-1554n of computers 1544A-1544n may not be executed in a fixed location, i.e., processing steps 1554A-1554n can be executed in different locations (e.g., on different processors). Sequential data stores 1546A-1546n and metadata data store 1548 can also be on-premises data stores or can be cloud-based and available through a same or different cloud service as source data store 1540 and/or computers 1544A-1544n in examples where source data store 1540 and/or computers 1544A-1544n are also cloud-based.

Source data store 1540 is a collection of electronic data. Source data store 1540 can be a relational, non-relational, or other data storage type. In some examples, source data store 1540 can be a database, such as an Oracle database, an Azure SQL database, or any other type of database. In some examples, source data store 1540 can be a data lake or a zone or container defined within a data lake. In other examples, source data store 1540 can be a SharePoint list or flat file type, such as an Excel spreadsheet. In yet other examples, source data store 1540 can be any suitable store of electronic data. Although a single source data store 1540 is depicted in FIG. 14 for purposes of clarity and ease of discussion, it should be understood that data processing system 1500 can include any number of source data stores 1540. System 1500 can, in principle, include a large and scalable number of source data stores 1540. In examples where there is more than one source data store 1540, individual source data stores 1540 can be the same type of data store or can be different types of data stores.

Data located in source data store 1540 can be in any suitable electronic data format. For example, the data can be structured (e.g., rows and columns in a relational database), unstructured, or semi-structured. In some examples, source data store 1540 stores business data, such as employee information, customer information, sales information, financial information, etc., for an organization. In other examples, source data store 1540 can store any type of electronic data. In examples where there is more than one source data store 1540, individual source data stores 1540 can store the same or different types of data.

Source data object 1542 represents all or a portion of the data located in source data store 1540. For example, source data object 1542 can be a file. In some examples, source data object 1542 can be a Parquet file. Although a single source data object 1542 is depicted in FIG. 14 for purposes of clarity and ease of discussion, it should be understood that source data store 1540 can include any number of source data objects 1542, including multiple source data objects 1542.

Computers 1544A-1544n include corresponding processors 1550A-1550n and memory 1552A-1552n. Although each of processors 1550A-1550n and corresponding memory 1552A-1552n are illustrated in FIG. 14 as being separate components of a corresponding computer device (e.g., computer 1544A includes processor 1550A and memory 1552A), it should be understood that in other examples, each of processors 1550A-1550n and corresponding memory 1552A-1552n can be distributed among multiple connected devices. In yet other examples, memory 1552A-1552n can be a component of corresponding processor 1550A-1550n. In yet other examples, computers 1544A-1544n can be a single computer device that includes all the functionality of processors 1550A-1550n and memory 1552A-1552n, such that, e.g., processing steps 1554A-1554n are all carried out by the same computer.

Processors 1550A-1550n are configured to implement functionality and/or process instructions within data processing system 1500. For example, processors 1550A-1550n can be capable of processing instructions stored in memory 1552A-1552n. Examples of processors 1550A-1550n can include one or more of a processor, a microprocessor, a controller, a digital signal processor (DSP), an application specific integrated circuit (ASIC), a field-programmable gate array (FPGA), or other equivalent discrete or integrated logic circuitry.

Memory 1552A-1552n can be configured to store information before, during, and/or after operation of data processing system 1500. Memory 1552A-1552n, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 1552A-1552n can be entirely or partly temporary memory, meaning that a primary purpose of memory 1552A-1552n is not long-term storage. Memory 1552A-1552n, in some examples, is described as volatile memory, meaning that memory 1552A-1552n does not maintain stored contents when power to devices (e.g., computers 1544A-1544n) is turned off. Examples of volatile memories can include random access memories (RAM), dynamic random access memories (DRAM), static random access memories (SRAM), and other forms of volatile memories. Memory 1552A-1552n, in some examples, also includes one or more computer-readable storage media. Memory 1552A-1552n can be configured to store larger amounts of information than volatile memory. Memory 1552A-1552n can further be configured for long-term storage of information. In some examples, memory 1552A-1552n includes non-volatile storage elements. Examples of such non-volatile storage elements can include magnetic hard discs, optical discs, flash memories, or forms of electrically programmable memories (EPROM) or electrically erasable and programmable (EEPROM) memories.

Memory 1552A-1552n is encoded with instructions that are executed by corresponding processors 1550A-1550n. For example, memory 1552A-1552n can be used to store program instructions for execution of processing steps 1554A-1554n on processors 1550A-1550n. In some examples, memory 1552A-1552n is used by software or applications running on processors 1550A-1550n, e.g., processing steps 1554A-1554n, to temporarily store information during program execution.

Processing steps 1554A-1554n are each a set of code for processing data objects 1542, 1556A-1556n. For example, processing steps 1554A-1554n can be a copy activity or sequence of activities in Azure Data Factory (ADF) (i.e., an ADF pipeline), a Databricks Notebook, another program, etc. In an example where sequentially last data store 1546n is an embodiment of target data warehouse 1114 (FIG. 9), processing step 1554n can represent either dimension template 1124 or fact template 1216 (FIG. 9).

Processing steps 1554A-1554n are each defined by a corresponding processing step definition (block 1610 in FIG. 15), which represents a set or category of metadata associated with processing steps 1554A-1554n. Processing step definitions are a first set of process definition metadata that corresponds to processing steps 1554A-1554n in the process definition of data processing system 1500. Processing step definition metadata can include an indication of the type of processing step for each processing steps 1554A-1554n. Processing step definition metadata can also include or reference a subject area for classifying processing steps 1554A-1554n and a stage within data processing system 1500 (e.g., first stage 1510, intermediate stage 1520, final stage 1530) that is associated with respective processing steps 1554A-1554n. For example, these attributes can be predefined based on the process definition. The code associated with each processing step 1554A-1554n can include a method for automatically populating records (e.g., rows) into the processing step definition metadata set (e.g., table) in metadata data store 1548. Accordingly, one part of runtime metadata generated and stored by data processing system 1500 is the records populated into the first process definition metadata set for processing step definition metadata.

Processing steps 1554A-1554n are also executed, which results in instances of processing steps 1554A-1554n. There is a set or category of instance metadata associated with each processing step instance (block 1640 in FIG. 15). Processing step instance metadata can include an identification of a run (an instance) of each processing step 1554A-1554n, a date or time of the run, a duration of the run, or other metadata. The code associated with each processing step 1554A-1554n can include a method for automatically storing the processing step instance metadata in metadata data store 1548. Accordingly, another part of the runtime metadata generated and stored by data processing system 1500 is the processing step instance metadata. In some examples, the processing step instance metadata can be linked or correlated to a corresponding record in the processing step definition metadata table.

Each of processing steps 1554A-1554n can be succeeded by another one of processing steps 1554A-1554n (i.e., a processing step successor). For example, as illustrated in FIG. 14, processing step 1554A can be succeeded by processing step 1554B. Processing step successors are each defined by a corresponding processing step successor definition (block 1620 in FIG. 15), which represents a set or category of metadata associated with processing step successors. Processing step successor definitions are a second set of process definition metadata that corresponds to processing step successors in the process definition of data processing system 1500. Processing step successor definition metadata can include or capture the relationship between each of processing steps 1554A-1554n and a corresponding successor. That is, processing step successor definition metadata indicates which of processing steps 1554A-1554n preceded the processing step successor. In some examples, processing step definition metadata can create an execution graph or processing spectrum of the sequence or organization of processing steps 1554A-1554n (processing step and processing step successor) in data processing system 1500. For example, these attributes can be predefined based on the process definition. The code associated with each processing step 1554A-1554n can include a method for automatically populating records (e.g., rows) into the processing step successor definition metadata set (e.g., table) in metadata data store 1548. Accordingly, another part of the runtime metadata generated and stored by data processing system 1500 is the records populated into the second process definition metadata set for processing step successor definition metadata

Each of processing steps 1554A-1554n can also include one or more data transformations (i.e., transformation processing steps). Transformation processing steps are executed as processing steps 1554A-1554n are executed, which results in instances of the transformation processing steps. There is a set or category of instance metadata associated with each transformation processing step instance (block 1650 in FIG. 15). Transformation processing step instance metadata can include an identification of a run (an instance) of an individual transformation step within one of processing steps 1554A-1554n, a date or time of the run, a duration of the run, a record count of records operated on in the transformation step, an indication of operations performed in the transformation step, a log of an actual code statement associated with the transformation step (e.g., as input by a user), or other metadata. The code associated with each processing step 1554A-1554n can include a method for automatically storing the transformation processing step instance metadata in metadata data store 1548. Accordingly, another part of the runtime metadata generated and stored by data processing system 1500 is the transformation processing step instance metadata. In some examples, this metadata can be linked or correlated to a corresponding record in the processing step definition or processing step instance metadata tables.

In an example where processing step 1554n is either dimension template 1124 or fact template 1126 (FIG. 9), transformation processing steps can be any one or more transformations performed in, e.g., corresponding fifth module 1316, 1416 or another module. In particular, the transformation processing steps can correspond to ones of modules 1310-1326 for dimension template 1124 or modules 1410-1426 for fact template 1126 where a user input code statement is entered. In some examples, templates 1124, 1126 can include an instruction to a user to call a method for storing the transformation processing step instance metadata associated with the transformation that was performed. In some examples, this instruction may be included if a particular transformation is generally more complex than other steps in the template. In general, there may not be separate definition metadata (e.g., based on the process definition of data processing system 1500) associated with any transformation processing steps because the transformations that are executed in processing steps 1554A-1554n can be application-specific (i.e., can depend on the business logic for a particular application).

Sequential data stores 1546A-1546n are destination data stores for data processed via a preceding one of processing steps 1554A-1554n. Sequential data stores 1546A-1546n can be located remotely from source data store 1540. Each of sequential data stores 1546A-1546n can be, for example, a data warehouse zone defined within a data lake. That is, each of sequential data stores 1546A-1546n can be a different zone or container within a data lake that is accessed during a different portion of an ETL process (e.g., a different stage 1510, 1520, 1530 of data processing system 1500). In other examples, sequential data stores 1546A-1546n can be any suitable data store type. Sequential data stores 1546A-1546n store corresponding data objects 1556A-1556n (e.g., sequential data store 1546A stores data object 1556A, etc.), including transformed data to be used for tasks such as reporting, visualization, analytics, machine learning, etc.

Data located in sequential data stores 1546A-1546n can be in any suitable electronic data format. For example, the data can be structured (e.g., rows and columns in a relational database), unstructured, or semi-structured. In some examples, sequential data stores 1546A-1546n store business data, such as employee information, customer information, sales information, financial information, etc., for an organization. In other examples, sequential data stores 1546A-1546n can store any type of electronic data. Individual ones of sequential data stores 1546A-1546n can store the same or different types of data.

Data objects 1556A-1556n are data objects stored in a corresponding one of sequential data stores 1546A-1546n (e.g., data object 1556A is stored in sequential data store 1546A, etc.). Data objects 1556A-1556n represent all or a portion of the data located in the respective sequential data store 1546A-1546n. For example, data objects 1556A-1556n can be files. In some examples, data objects 1556A-1556n can be Parquet files. Although a single data object 1556A-1556n is depicted within each corresponding data store 1546A-1546n in FIG. 14 for purposes of clarity and ease of discussion, it should be understood that each data store 1546A-1546n can include any number of corresponding data objects 1556A-1556n, including multiple corresponding data objects 1556A-1556n.

Data objects 1556A-1556n can be consumed (or read) by one or more of processing steps 1554A-1554n. In the example shown in FIG. 14, source data object 1542 is read by processing step 1554A, data object 1556A is read by processing step 1554B, and data object 1556B is read by a sequentially next processing step (e.g., processing step 1554n in FIG. 14). Data objects 1556A-1556n can also be produced (or written) by one of processing steps 1554A-1554n. In the example shown in FIG. 14, data object 1556A is produced by processing step 1554A, data object 1556B is produced by processing step 1554B, and data object 1556n is produced by a sequentially previous processing step (e.g., processing step 1554n in FIG. 14).

Data objects 1556A-1556n are each defined by a corresponding data object artifact (block 1630 in FIG. 15), which represents a set or category of metadata associated data objects 1556A-1556n. Data object artifacts are a third set of process definition metadata that corresponds to data objects 1556A-1556n in the process definition of data processing system 1500. Data object artifact metadata can include an indication of the type of data object (e.g., Parquet file, Hive table, etc.) for each of data objects 1556A-1556n, an identification of the one of processing steps 1554A-1554n that produced or consumed each of data objects 1556A-1556n, and record count thresholds for records read or written from data objects 1556A-1556n. For example, these attributes can be predefined based on the process definition. In some examples, record count thresholds are preset. In some examples, preset thresholds include a minimum record count (such as at least one record) and/or a maximum record count. In other examples, record count thresholds can be manually set or refined for particular data object types. If record counts are outside the thresholds, data processing system 1500 can still proceed (e.g., for data governance purposes) but can generate an alert to indicate a deviation with respect to the threshold. In some examples, the alert can direct a user to a code statement that is associated with an operation (e.g., a transformation) in the respective processing step 1554A-1554n for reading or writing the records. The code associated with each processing step 1554A-1554n that produces or consumes data objects 1556A-1556n can include a method for automatically populating records (e.g., rows) into the data object artifact metadata set (e.g., table) in metadata data store 1548. Accordingly, another part of the runtime metadata generated and stored by data processing system 1500 is the records populated into the third process definition metadata set for data object artifact metadata.

Processing data objects 1556A-1556n by a corresponding processing step 1554A-1554n results in an instance of the processed data object 1556A-1556n. Processing data objects 1556A-1556n by a corresponding processing step 1554A-1554n includes performing an operation on the respective data object 1556A-1556n, such as consuming (reading) or producing (writing) the respective data object 1556A-1556n. The instances of each data object 1556A-1556n are actual data structures such as files that are read or written. Accordingly, each data object instance can have a type or file type that is represented by the corresponding data object artifact record. For each data object artifact associated with one of data objects 1556A-1556n, there can be multiple data object instances because data objects 1556A-1556n can be read and written multiple times by operation of data processing system 1500. There is a set or category of instance metadata associated with each data object instance (block 660 in FIG. 15). Data object instance metadata can include an identification of an instance of one of data objects 1556A-1556n, a date or time that the data object instance was read or written, a duration of the operation (reading or writing), a record count of records that were read or written, an indication of the operation performed (reading or writing), or other metadata. The code associated with each processing step 1554A-1554n that produces or consumes data objects 1556A-1556n can include a method for automatically storing the data object instance metadata in metadata data store 1548. Accordingly, another part of the runtime metadata generated and stored by data processing system 1500 is the data object instance metadata. In some examples, this metadata can be linked or correlated to a corresponding record in the data object artifact metadata table.

Metadata data store 1548 is a data store for storing metadata gathered in data processing system 1500. For example, metadata data store 1548 can be a relational database. In some examples, metadata data store 1548 is an Azure SQL database. In other examples, metadata data store can be any suitable data store type. Specifically, metadata data store 1548 stores the processing step definition metadata, processing step instance metadata, processing step successor definition metadata, transformation processing step instance metadata, data object artifact metadata, and data object instance metadata. Metadata data store 1548 (e.g., metadata within metadata data store 1548) can be accessible by users, such as developers or data analysts. Metadata data store 1548 can also be connected to other applications or programs for augmenting the metadata with other information, such as visualizations, descriptions, or other documentation.

FIG. 15 depicts example schema 1600 for organizing the metadata in metadata data store 1548. Each of blocks 1610-660 can represent a table or similar data structure. That is, each category of metadata (i.e., processing step definition metadata, processing step instance metadata, processing step successor definition metadata, transformation processing step instance metadata, data object artifact metadata, and data object instance metadata) can be stored in a corresponding table in metadata data store 1548. Schema 1600 can also include additional tables for organizing other categories of information, such as a subject area for each processing step 1554A-1554n and/or each data object 1556A-1556n or a stage for each processing step 1554A-1554n. Further, schema 1600 is merely one example of an organizational structure for storing metadata from data processing system 1500 (as described above), and it should be understood that other organizational structures are possible. In the example shown in FIG. 15, the dashed lines indicate relationships between the tables. Each processing step 1554A-1554n (block 1610) can be succeeded by a processing step successor (block 1620). Each execution of processing steps 1554A-1554n creates a corresponding instance or run of the processing step (processing step instance 1640), and each processing step instance can include transformation processing step instances (block 1650) for each individual transformation within the processing step. Processing steps 1554A-1554n produce or consume data objects 1540, 1556A-1556n (data object artifact block 1630), and each data object that is produced or consumed has a corresponding instance (block 660). Though not shown in FIG. 15 for simplicity and ease of discussion, any many-to-many relationships between ones of blocks 1610-660 could also have a separate join table to resolve the many-to-many relationship. For example, one or more processing steps 1554A-1554n can consume one or more data objects 1556A-1556n, so schema 1600 could include a join table between data object artifact block 1630 and processing step definition block 1610 for consumption steps.

The operation of data processing system 1500 will be described with reference to FIGS. 14--16. As illustrated in FIG. 16, a first step of process 1700 for gathering metadata in data processing system 1500 is to define metadata sets or categories based on the process definition of data processing system 1500 (step 1710). A first set of metadata that is defined can correspond to processing steps 1554A-1554n (e.g., processing step definition metadata). A second set of metadata that is defined can correspond to processing step successors of respective ones of processing steps 1554A-1554n (e.g., processing step successor definition metadata). A third set of metadata that is defined can correspond to data objects 1556A-1556n (e.g., data object artifact metadata).

At step 1720 of process 1700, processing steps 1554A-1554n of data processing system 1500 are executed according to the process definition. For example, executing processing steps 1554A-1554n can include executing an extract-transform-load (ETL) process that is encompassed by data processing system 1500. At step 1730, metadata is generated during an execution of processing steps 1554A-1554n of data processing system 1500. For example, the metadata generated in step 1730 can include runtime metadata. The runtime metadata generated in data processing system 1500 can include the processing step definition metadata, the processing step instance metadata, the processing step successor definition metadata, the transformation processing step instance metadata, the data object artifact metadata, and the data object instance metadata.

At step 1740, the metadata that was generated in step 1730 is stored in metadata data store 1548 during a run of data processing system 1500 via the execution of processing steps 1554A-1554n. For example, the metadata stored in metadata data store 1548 can include the runtime metadata. Metadata data store 1548 can store the processing step definition metadata, the processing step instance metadata, the processing step successor definition metadata, the transformation processing step instance metadata, the data object artifact metadata, and the data object instance metadata. Methods (code) in each of processing steps 1554A-1554n can cause corresponding metadata to be automatically populated into metadata data store 1548 and organized according to schema 1600.

Storing metadata in metadata data store 1548 further includes forming metadata data store 1548 that integrates the runtime metadata and the metadata sets of process definition metadata. For example, metadata data store 1548 can integrate the runtime metadata and the metadata sets of process definition metadata when records are automatically populated into the processing step definition metadata table, the processing step successor definition metadata table, and/or the data object artifact metadata table, and these tables are correlated with the processing step instance metadata, the transformation processing step instance metadata, and/or the data object instance metadata that is also automatically recorded.

In one non-limiting example, processing step 1554n can be an embodiment of dimension template 1124 (FIGS. 9-13) such that common processing class 1210 (e.g., auditing component 1212 and/or transformation processing component 1214) is inherited by dimension processing class 1216 and can include methods for automatically populating metadata into metadata data store 1548 when dimension template 1124 is executed. Specifically, the methods called in dimension template 1124 can populate: (a) a record into the processing step definition metadata table for dimension template 1124, (b) processing step instance metadata for the execution of dimension template 1124, (c) transformation processing step instance metadata for one or more transformations in dimension template 1124, (d) a record into the data object artifact metadata table for any data objects 1118A-1118n that are read or written to create dimension tables 1132, and (e) data object instance metadata for any data objects 1118A-1118n that were read or written to create dimension tables 1132.

In another non-limiting example, processing step 1554n can be an embodiment of fact template 1126 (FIGS. 9-13) such that common processing class 1210 (e.g., auditing component 1212 and/or transformation processing component 1214) is inherited by fact processing class 1218 and can include methods for automatically populating metadata into metadata data store 1548 when fact template 1126 is executed. Specifically, the methods called in fact template 1126 can populate: (a) a record into the processing step definition metadata table for fact template 1126, (b) processing step instance metadata for the execution of fact template 1126, (c) transformation processing step instance metadata for one or more transformations in fact template 1126, (d) a record into the data object artifact metadata table for any data objects 1118A-1118n that are read or written to create fact table 1130, and (e) data object instance metadata for any data objects 1118A-1118n that were read or written to create fact table 1130.

Metadata that is generated in data processing system 1500 and stored in metadata data store 1548 provides a historical, data-tracking viewpoint, which can enable locating errors or inefficiencies in data processing system 1500. For example, the metadata can be used to determine opportunities to optimize data processing system 1500. In one example, there could be a bottleneck in the process caused by a section of inefficient code. The robust metadata in metadata data store 1548, including detailed origin, lineage, and context information, can help identify the inefficient code and enable a developer to quickly improve the code. In another example, the metadata in metadata data store 1548 can be used to track compliance with validity requirements in the data, such as legal, privacy, validity of inclusion, or other requirements. In one example, if a PII violation happens, a user can trace the occurrence with the metadata to find when or how the violation occurred. Similarly, in a healthcare example, the metadata could be used to verify that certain patients were not included in a particular cohort and enable a user to trace any violations of this rule.

Often, an organization will lack insight into the origin of its data (Where did the data come from?), the lifecycle or lineage of the data (What happened to the data?), and the context of the data (How is the measure calculated?). For example, tables can be combined, data types can be changed, etc., and these insights can be lost. Typically, this information about the data would have been momentarily available as the process was occurring but would not have been stored. Gathering metadata manually can be exceedingly difficult and problematic due to the outright burden of gathering so much data and because a process might fail if it depends on metadata that was not properly recorded or updated.

Moreover, commercially available data cataloging options tend to have an “outside looking in” perspective of the data so that a user might be able to obtain basic information about the data, such as counts of records read or written or—with some manual input—basic lineage information, but the user would not have access to deeper insights about the data. Data catalogs can be broadly classified as curated data catalogs, which are hand-maintained pages of information about the data, or automated data catalogs, which have some ability to “discover” data that is stored in a data store. Curated data catalogs are limited in that they are both time and labor-intensive to develop and maintain and tend to become stale or out of data quickly if they are not rigorously maintained. Automated data catalogs are limited in that they require a very large investment in human capital and management so tend to be cost-prohibitive for all but the largest organizations and the automated components still lack significant data governance and data quality aspects. In general, data catalogs lack integration with the data processing system. However, many organizations want rich auditing capabilities for their business data.

Data processing system 1500 is a metadata-based system because it has a process definition that predefines a sequence of processing steps 1554A-1554n and respective data stores (source data store 1540 and sequential data stores 1546A-1546n) from which data objects 1542, 1554A-1554n are produced or consumed. Because data processing system 1500 is already a metadata-based system, according to techniques of this disclosure, data processing system 1500 can capture all of the information that would be available from a traditional data catalog and associate that information with details of the actual processing or runtime data. Traditional data catalogs are unable to deliver this type of integrated information.

Data processing system 1500 automatically populates records and metadata in metadata data store 1548, which presents a significant competitive advantage that is partially due to automation. For example, as processing steps 1554A-1554n are executed, metadata in metadata data store 1548 is automatically maintained (kept up to date). Further, the metadata gathering can be integrated at every step of data processing system 1500. Having metadata data store 1548 with more robust and detailed metadata about data processing system 1500 can improve an organization’s trust in their data.

Additionally, the metadata in metadata data store 1548 can serve as a base of information for further analytics or other uses. For example, the metadata could be used for machine learning to propose optimizations to data processing system 1500 or propose alternative approaches. The metadata in metadata data store 1548 can also be used by other applications that allow users to augment the metadata. For example, one of processing steps 1554A-1554n might include a complicated calculation; a user can access metadata data store 1548 to see the transformation that was done; this metadata can be linked via an augmentation application to a diagram that explains the logic; and the user can refer to the diagram when reviewing the data to determine if the calculation was performed correctly. Thus, the robust metadata gathered from data processing system 1500 enables various extensions or augmentations of the information which would not otherwise be possible.

Although depicted in FIGS. 1-16 as separate examples, a data processing system according to techniques of this disclosure can include any combination of the foregoing features. Further, several features of the data processing system described herein are scalable and/or modifiable. For example, because data pipeline system 10 of FIGS. 1-2 can include any number of data sources 20A-20n, additional data sources 20A-20n can be added to system 10 or ones of data sources 20A-20n can be removed from system 10. If new or additional data sources 20A-20n are added, the metadata that corresponds to the new data sources 20A-20n can be added to metadata table 54. Metadata can also be removed from metadata table 54 if ones of data sources 20A-20n are removed. Similarly, data processing system 1500 of FIGS. 14-15 can be modified to include additional and/or different processing steps 1554A-1554n and/or data objects 1556A-1556n. These modifications would be reflected in the process definition of data processing system 1500 and in schema 1600 for organizing metadata from data processing system 1500. That is, information about the additional or different processing steps 1554A-1554n or data objects 1556A-1556n could be added to the corresponding metadata sets in schema 1600. In another example, data processing system 1000 of FIGS. 9-12 can be modified by adding, removing, and/or changing the methods that are organized in class infrastructure 1200.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method of processing electronic data in a data processing system, the method comprising:
defining metadata sets of process definition metadata based on a process definition of the data processing system, the metadata sets including:
a first set of metadata corresponding to a processing step of the data processing system;
a second set of metadata corresponding to a processing step successor that succeeds the processing step in the data processing system; and
a third set of metadata corresponding to a data object that is produced or consumed by the processing step in the data processing system;
organizing data source metadata corresponding to a plurality of data sources into a data structure, wherein the data source metadata includes information that enables identifying and connecting to each data source of the plurality of data sources;
storing the data structure on a database such that the data structure is configured to be queried to retrieve the data source metadata;
executing one or more steps of the data processing system via a computer device according to the process definition; wherein a first step of the data processing system is an ordered sequence of activities that corresponds to a data ingestion pipeline that is initiated by querying the data structure to retrieve metadata corresponding to one or more data sources of the plurality of data sources; and wherein executing the ordered sequence of activities includes:
connecting to a respective one of the one or more data sources using a portion of the metadata that corresponds to the respective one of the one or more data sources to form a connection to the respective one of the one or more data sources;
accessing, from the respective one of the one or more data sources via the connection, a respective data object specified by the portion of the metadata that corresponds to the respective one of the one or more data sources; and
storing the respective data object in a data lake, the data lake being remote from each of the data sources;
generating runtime metadata during an execution of the one or more data processing system steps, the runtime metadata including:
metadata that corresponds to an instance of the processing step; and
metadata that corresponds to an instance of the data object;
storing the runtime metadata during the execution of the one or more data processing system steps; and
forming a metadata data store that integrates the runtime metadata and the metadata sets of process definition metadata.

2. A method of processing electronic data in a data processing system for creating a data warehouse, the method comprising:
defining process definition metadata based on a process definition of the data processing system, wherein the process definition includes an ordered sequence of processing steps;
organizing data source metadata corresponding to a plurality of data sources into a data structure, wherein the data source metadata includes information that enables identifying and connecting to each data source of the plurality of data sources;
executing the ordered sequence of processing steps of the process definition via a computer device, wherein a first processing step of the ordered sequence of processing steps includes using the data source metadata in ingesting data from one or more data sources of the plurality of data sources into a first data store, and wherein a second processing step of the ordered sequence of processing steps includes using a stored template to create a dimension table or a fact table in a second data store based on the data ingested in the first processing step;
generating runtime metadata during an execution of the ordered sequence of processing steps;
storing the runtime metadata during the execution of the ordered sequence of processing steps; and
forming a metadata data store that integrates the runtime metadata with the process definition metadata.

3. The method of claim 2, wherein the process definition metadata includes:
a first set of metadata corresponding to each processing step of the ordered sequence of processing steps;
a second set of metadata corresponding to processing step successors that succeed a respective processing step of the ordered sequence of processing steps; and
a third set of metadata corresponding to data objects that are produced or consumed by each processing step of the ordered sequence of processing steps.

4. The method of claim 3, wherein the first processing step of the ordered sequence of processing steps further includes:
initiating, by the computer device, a data pipeline by performing a lookup activity, the lookup activity including querying the data structure to retrieve respective data source metadata corresponding to the one or more data sources of the plurality of data sources; and
performing, by the computer device, a first subset sequence of activities for each of the one or more data sources, the first subset sequence of activities including:
connecting to a respective one of the one or more data sources using a portion of the data source metadata that corresponds to the respective one of the one or more data sources to form a connection to the respective one of the one or more data sources;
accessing, from the respective one of the one or more data sources via the connection, a first data object specified by the portion of the data source metadata that corresponds to the respective one of the one or more data sources; and
storing the first data object in the first data store, the first data store being remote from each data source of the plurality of data sources.

5. The method of claim 4, wherein the second processing step of the ordered sequence of processing steps further includes:
accessing, by the computer device, a second subset sequence of activities that are arranged in the stored template, the second subset sequence of activities including:
importing code associated with the second subset sequence of activities;
defining standard variables for the stored template;
creating an instance of a dimension processing class or a fact processing class, wherein a first set of code associated with creating the dimension table is organized into the dimension processing class, a second set of code associated with creating the fact table is organized into the fact processing class, and a third set of code associated with creating both the dimension table and the fact table is organized into a common processing class;
reading a second data object from the first data store;
performing one or more transformations on the second data object;
identifying attributes of the second data object;
writing the second data object into a target table in the second data store; and
performing one or more checks on the target table;
executing, via the computer device, the second subset sequence of activities that are arranged in the stored template;
creating the dimension table when the instance of the dimension processing class is created in the second subset sequence of activities; and
creating the fact table when the instance of the fact processing class is created in the second subset sequence of activities.

6. The method of claim 3, wherein a first data object from one of the plurality of data sources is consumed by the first processing step; wherein a second data object in the first data store is produced by the first processing step and consumed by the second processing step; wherein a third data object in the second data store is produced by the second processing step; wherein the third data object is the dimension table when the stored template is a dimension table creation template; and wherein the third data object is the fact table when the stored template is a fact table creation template.

7. The method of claim 3, wherein the runtime metadata includes:
metadata that corresponds to instances of each processing step of the ordered sequence of processing steps; and
metadata that corresponds to instances of the data objects.

8. The method of claim 7, wherein forming the metadata data store further includes correlating the metadata that corresponds to the instances of each processing step of the ordered sequence of processing steps with the first set of metadata and correlating the metadata that corresponds to the instances of the data objects with the third set of metadata.

9. The method of claim 2, wherein one or more processing steps of the ordered sequence of processing steps includes a transformation step, and wherein the runtime metadata includes metadata that corresponds to an instance of the transformation step.

10. The method of claim 2, wherein the runtime metadata is automatically generated during the execution of the ordered sequence of processing steps by methods that are included in respective processing steps of the ordered sequence of processing steps.

11. The method of claim 2, wherein the metadata data store is a relational database, and wherein the process definition metadata is represented by corresponding tables included in a schema of the metadata data store.

12. The method of claim 2, wherein the first processing step of the ordered sequence of processing steps further includes:
initiating, by the computer device, a data pipeline by performing a lookup activity, the lookup activity including querying the data structure to retrieve respective data source metadata corresponding to the one or more data sources of the plurality of data sources; and
performing, by the computer device, a first subset sequence of activities for each of the one or more data sources, the first subset sequence of activities including:
connecting to a respective one of the one or more data sources using a portion of the data source metadata that corresponds to the respective one of the one or more data sources to form a connection to the respective one of the one or more data sources;
accessing, from the respective one of the one or more data sources via the connection, a first data object specified by the portion of the data source metadata that corresponds to the respective one of the one or more data sources; and
storing the first data object in the first data store, the first data store being remote from each data source of the plurality of data sources.

13. The method of claim 12, wherein the second processing step of the ordered sequence of processing steps further includes:
accessing, by the computer device, a second subset sequence of activities that are arranged in the stored template, the second subset sequence of activities including:
importing code associated with the second subset sequence of activities;
defining standard variables for the stored template;
creating an instance of a dimension processing class or a fact processing class, wherein a first set of code associated with creating the dimension table is organized into the dimension processing class, a second set of code associated with creating the fact table is organized into the fact processing class, and a third set of code associated with creating both the dimension table and the fact table is organized into a common processing class;
reading a second data object from the first data store;
performing one or more transformations on the second data object;
identifying attributes of the second data object;
writing the second data object into a target table in the second data store; and
performing one or more checks on the target table;
executing, via the computer device, the second subset sequence of activities that are arranged in the stored template;
creating the dimension table when the instance of the dimension processing class is created in the second subset sequence of activities; and
creating the fact table when the instance of the fact processing class is created in the second subset sequence of activities.

14. The method of claim 12, wherein the portion of the data source metadata that corresponds to the respective one of the one or more data sources includes a key value that is associated with the access credentials for the respective one of the one or more data sources, and wherein connecting to the respective one of the one or more data sources further comprises:
parameterizing a linked services module based on the portion of the data source metadata that corresponds to the respective one of the one or more data sources;
forming the connection to the respective one of the one or more data sources via the linked services module;
connecting, via the linked services module, to a secure storage that contains access credentials for the respective one of the one or more data sources;
obtaining the access credentials for the respective one of the one or more data sources from the secure storage by passing the key value to the secure storage via the linked services module; and
using the access credentials for the respective one of the one or more data sources in forming the connection to the respective one of the one or more data sources via the linked services module.

15. The method of claim 12, wherein storing the first data object in the first data store further comprises incorporating values from the portion of the data source metadata that corresponds to the respective one of the one or more data sources into a file name of the first data object to enable identifying the first data object in the first data store.

16. The method of claim 15, wherein the process definition metadata includes:
a first set of metadata corresponding to each processing step of the ordered sequence of processing steps;
a second set of metadata corresponding to processing step successors that succeed a respective processing step of the ordered sequence of processing steps; and
a third set of metadata corresponding to data objects that are produced or consumed by each processing step of the ordered sequence of processing steps.

17. The method of claim 16, wherein the runtime metadata includes:
metadata that corresponds to instances of each processing step of the ordered sequence of processing steps; and
metadata that corresponds to instances of the data objects.

18. The method of claim 17, wherein forming the metadata data store further includes correlating the metadata that corresponds to the instances of each processing step of the ordered sequence of processing steps with the first set of metadata and correlating the metadata that corresponds to the instances of the data objects with the third set of metadata.

19. The method of claim 12, wherein storing the first data object in the first data store further comprises:
creating a copy of the first data object from the respective one of the one or more data sources and storing the copy of the first data object in the first data store; and
writing the copy of the first data object to a container within the first data store, the container being a destination for respective copies of data objects accessed from each of the one or more data sources.

20. The method of claim 12, wherein the first data object comprises a new or updated portion of data stored in the respective one of the one or more data sources.

21. The method of claim 2, wherein the second processing step of the ordered sequence of processing steps further includes:
accessing, by the computer device, a second subset sequence of activities that are arranged in the stored template, the second subset sequence of activities including:
importing code associated with the second subset sequence of activities;
defining standard variables for the stored template;
creating an instance of a dimension processing class or a fact processing class, wherein a first set of code associated with creating the dimension table is organized into the dimension processing class, a second set of code associated with creating the fact table is organized into the fact processing class, and a third set of code associated with creating both the dimension table and the fact table is organized into a common processing class;
reading a second data object from the first data store;
performing one or more transformations on the second data object;
identifying attributes of the second data object;
writing the second data object into a target table in the second data store; and
performing one or more checks on the target table;
executing, via the computer device, the second subset sequence of activities that are arranged in the stored template;
creating the dimension table when the instance of the dimension processing class is created in the second subset sequence of activities; and
creating the fact table when the instance of the fact processing class is created in the second subset sequence of activities.

22. The method of claim 21, wherein the common processing class, the dimension processing class, and the fact processing class are organized in a class infrastructure such that the common processing class is a parent class and the dimension and fact processing classes are child classes that inherit from the common processing class.

23. The method of claim 21, wherein the code associated with the second subset sequence of activities further includes:
a fourth set of code associated with auditing steps; and
a fifth set of code associated with transformation steps;
wherein the fourth and fifth sets of code are components of the common processing class.

24. The method of claim 23, wherein the fourth and fifth sets of code include one or more methods for generating and storing respective runtime metadata associated with the second processing step when the second subset sequence of activities is executed.

25. The method of claim 24, wherein the process definition metadata includes:
a first set of metadata corresponding to each processing step of the ordered sequence of processing steps;
a second set of metadata corresponding to processing step successors that succeed a respective processing step of the ordered sequence of processing steps; and
a third set of metadata corresponding to data objects that are produced or consumed by each processing step of the ordered sequence of processing steps.

26. The method of claim 25, wherein the runtime metadata includes:
metadata that corresponds to instances of each processing step of the ordered sequence of processing steps; and
metadata that corresponds to instances of the data objects.

27. The method of claim 26, wherein forming the metadata data store further includes correlating the metadata that corresponds to the instances of each processing step of the ordered sequence of processing steps with the first set of metadata and correlating the metadata that corresponds to the instances of the data objects with the third set of metadata.

28. The method of claim 2, wherein the data processing system includes an extract-transform-load (ETL) process.

29. A data processing system for processing electronic data to create a data warehouse, the system comprising:
a metadata data store including process definition metadata based on a process definition of the data processing system, wherein the process definition includes an ordered sequence of processing steps;
a data structure including data source metadata that corresponds to a plurality of data sources, wherein the data source metadata includes information that enables identifying and connecting to each data source of the plurality of data sources;
one or more processors; and
computer-readable memory encoded with instructions that, when executed by the one or more processors, cause the data processing system to:
access the process definition;
execute the ordered sequence of processing steps of the process definition, wherein a first processing step of the ordered sequence of processing steps includes using the data source metadata in ingesting data from one or more data sources of the plurality of data sources into a first data store, and wherein a second processing step of the ordered sequence of processing steps includes using a stored template to create a dimension table or a fact table in a second data store based on data ingested in the first processing step;
generate runtime metadata during an execution of the ordered sequence of processing steps; and
store the runtime metadata in the metadata data store during the execution of the ordered sequence of processing steps such that the metadata data store integrates the runtime metadata and the process definition metadata.
